(19) United States
(12) Patent Application Publication
(10) Pub. No.: US 2025/0126624 A1
(43) Pub. Date: Apr. 17, 2025

(54) SCI STAGE 2 DESIGN

(71) Applicant: Apple Inc., Cupertino, CA (US)

(72) Inventors: Chunxuan YE, San Diego, CA (US); Chunhai YAO, Beijing (CN); Dawei ZHANG, Saratoga, CA (US); Haitong SUN, Cupertino, CA (US); Hong HE, San Jose, CA (US); Huaning NIU, San Jose, CA (US); Oghenekome OTERI, San Diego, CA (US); Sigen YE, Whitehouse Station, NJ (US); Wei ZENG, Saratoga, CA (US); Weidong YANG, San Diego, CA (US)

(21) Appl. No.: 18/727,518

(22) PCT Filed: Jan. 10, 2022
(86) PCT No.: PCT/CN2022/071149

§ 371 Date: Jul. 9, 2024

(51) Int. Cl. H04W 72/25; H04W 72/0446

(52) U.S. Cl. CPC H04W 72/25; H04W 72/0446

(57) ABSTRACT

Systems, apparatus, methods, and computer programs for coordination of communications between user equipment (UE). In aspect, a method can include receiving, by UE-B, data transmitted by UE-A, the received data comprising stage 2 sidelink control information (SCI) and an inter-UE coordination (IUC) message, determining, by the UE-B, a number of N combinations of TRIV, FRIV, and periodicity in the stage 2 SCI based on at least a portion of the received data, determining, by the UE-B, a payload size of the stage 2 SCI based on the determined number of N combinations, and decoding, by the UE-B, inter-UE coordination (IUC) message comprising stage 2 SCI based on the determined payload size.

### BACKGROUND

The present disclosure relates to coordination of inter user equipment (inter-UE) communications in a mobile communication network.

### SUMMARY

Multiple schemes for inter-UE communication were discussed during the RAN1 #107-e meeting agreement.

### Scheme 1

For Scheme 1, a resource pool level (pre-)configuration approach was discussed to enable one of the following implementations.

In a first implementation, MAC CE or 2nd SCI can used as the container of inter-UE coordination information transmission from UE A to UE B. For the indication of resource set, N combinations of TRIV, FRIV, resource reservation period as specified in Rel-16 TS 38.214 Section 8.1.5 with following modification. In some implementations, the value of resource reservation period is omitted at least when the transmission of preferred resource set is triggered by UE-B's explicit request. Then, a first resource location of each TRIV is separately indicated by the inter-UE coordination information. Finally, of N<=3, MAC CE is used and it is up to UE implementation to additionally use 2nd SCI. When 2nd SCI and MAC CE are both used, the same resource set is indicated in the 2nd SCI and the MAC CE. If [N>3], only MAC CE is used. In this implementations, use of a 2nd SCI was UE RX optional. The details of UE capabilities were left for future study.

In a second implementations, a MAC CE is used as the container of inter-UE coordination information transmission from UE A to UE B. For the indication of resource set, N combinations of TRIV, FRIV, resource reservation period as specified in Rel-16 TS 38.214 Section 8.1.5 with following modification. In some implementations, the value of resource reservation period is omitted at least when the transmission of preferred resource set is triggered by UE-B's explicit request. Then, a first resource location of each TRIV is separately indicated by the inter-UE coordination information. Whether and/or how to use resource reservation information as coordination information was left for future study.

### Scheme 2

For Scheme 2, a resource pool level (pre-)configuration approach was discussed that uses either of the following implementations.

In a first implementation, a PSFCH occasion is derived by a slot where UE-B's SCI is transmitted. The agreement reuses PSSCH-to-PSFCH timing as specified in TS 38.213 Section 16.3 to determine the PSFCH occasion for resource conflict indication. The time gap between the PSFCH and a slot where expected/potential resource conflict occurs is larger than or equal to T_3.

In a second implementation, a PSFCH occasion is derived by a slot where expected/potential resource conflict occurs on PSSCH resource indicated by UE-B's SCI. UE-A transmits the PSFCH in a latest slot that includes PSFCH resources for inter-UE coordination information and is at least T_3 slots of the resource pool before the PSSCH resource indicated by UE-B's SCI in which expected/potential resource conflict occurs.

However, how to account for processing timeline was reserved for further study. And, note that it is possible not to configure either option 1 or option 2.

For aspects of Scheme 2, when “a non-destination UE of a TB transmitted by UE-B can be UE-A” is enabled or when “a non-destination UE of a TB transmitted by UE-B can be UE-A” is disabled and the destination UE of the conflicting TBs is UE-A, for each pair of UEs scheduling the conflicting TBs, a UE with the higher priority value is UE-B.

However, whether/how to set additional condition for UE-A to send PSFCH was reserved for further study.

In addition, whether/how to handle, or differently handle, the case when at least one of UEs scheduling conflicting TBs doesn't support Scheme 2 was reserved for further study.

According to one innovative aspect of the present disclosure as, a method for coordination of communications between user equipment (UE) is disclosed. In one aspect, the method can include receiving, by UE-B, data transmitted by UE-A, the received data comprising stage 2 sidelink control information (SCI) and an inter-UE coordination (IUC) message, determining, by the UE-B, a number of N combinations of TRIV, FRIV, and periodicity in the stage 2 SCI based on at least a portion of the received data, determining, by the UE-B, a payload size of the stage 2 SCI based on the determined number of N combinations, and decoding, by the UE-B, inter-UE coordination (IUC) message comprising stage 2 SCI based on the determined

Other aspects include apparatuses, systems, and computer programs for performing the actions of the aforementioned operations.

The innovative method can include other optional features. For example, in some implementations, the received data further comprises stage 1 SCI. In such implementations, determining, by the UE-B, a number of N combinations of TRIV, FRIV, and periodicity in the SCI stage 2 based on at least a portion of the received data can include decoding, by the UE-B, the received stage 1 SCI and obtaining, by the UE-B and from the decoded stage 1 SCI, second data corresponding to a number of N combinations of TRIV, FRIV, and periodicity in the SCI stage 2.

In some implementations, the obtained second data can refer to a configured table entry index.

In some implementations, determining, by the UE-B, a number of N combinations of TRIV, FRIV, and periodicity in the SCI stage 2 based on at least a portion of the received data can include decoding, by the UE-B, the received stage 2 SCI, and obtaining, by the UE-B and from the decoded stage 2 SCI, second data corresponding to a number of N combinations of TRIV, FRIV, and periodicity in stage 2 SCI.

In some implementations, the number of N combinations of TRIV, FRIV, and periodicity is less than or equal to 3. In such implementations, the number of N combinations of TRIV, FRIV, and periodicity is indicated using 2 bits of the stage 2 SCI.

In some implementations, the number of N combinations of TRIV, FRIV, and periodicity is less than or equal to 2. In such implementations, the number of N combinations of TRIV, FRIV, and periodicity is indicated using 1 bit of the stage 2 SCI.

In some implementations, the number of N combinations of TRIV, FRIV, and periodicity obtained from the stage 2 SCI is no more than a maximum number of N combinations of TRIV, FRIV, and periodicity.

In some implementations, the maximum number of N combinations of TRIV, FRIV, and periodicity is (pre-)configured based on a resource pool utilized by the UE-A and the UE-B.

In some implementations, determining, by the UE-B, a payload size of the stage 2 SCI based on the determined number of N combinations can include determining, by UE-B, a payload size of the stage 2 SCI based on the (pre-)configured maximum number of N combinations of TRIV, FRIV, and periodicity. In such implementations, decoding, by the UE-B, stage 2 SCI based on the calculated payload sizes can include disregarding additional fields for the maximum number of N combinations of TRIV, FRIV, and periodicity in the stage 2 SCI.

In some implementations, the maximum number of N combinations of TRIV, FRIV, and periodicity is a (pre-)configured based on a fixed value for the maximum number of N combinations of TRIV, FRIV, and periodicity.

In some implementations, determining, by the UE-B, a payload size of the stage 2 SCI based on the determined number of N combinations can include determining, by the UE-B, a payload size of the stage 2 SCI based on the (pre-)configured maximum number of N combinations of TRIV, FRIV, and periodicity. In such implementations, decoding, by the UE-B, stage 2 SCI based on the calculated payload sizes can include disregarding additional fields for the maximum number of N combinations of TRIV, FRIV, and periodicity in the stage 2 SCI.

In some implementations, the determined number of N combinations of TRIV, FRIV, and periodicity in the stage 2 SCI is the actual number of N combinations of TRIV, FRIV, and periodicity.

In some implementations, the IUC can further include data that separately indicates a first resource location of each TRIV.

In some implementations, the data that separately indicates the first resource location of each TRIV can include data indicating a reference slot that is a predetermined number of X slots after a (re)transmission of the PSCCH/PSSCH carrying the IUC, and data indicating a first resource location Y of each TRIV with respect to the reference slot.

In some implementations, the predetermined number of slots is a period of time for decoding the IUC.

In some implementations, the stage 2 SCI does not include (i) a HARQ feedback enabled/disabled indicator or (ii) a CSI request field.

In some implementations, the received data is transmitted using PSCCH/PSSCH.

In some implementations, the UE-A is user equipment that transmitted the received data using PSCCH/PSSCH, and the UE-B is user equipment that received the received data that was transmitted by the UE-A using PSCCH/PSSCH.

According to another innovative aspect of the present disclosure, another method for coordination of communications between user equipment (UE) is disclosed. In one aspect, the method can include receiving, by UE-B, data transmitted by UE-A, the received data comprising stage 2 sidelink control information (SCI) and an inter-UE coordination (IUC) message, determining, by the UE-B, a number of N combinations of TRIV, FRIV, and periodicity in the stage 2 SCI based on (pre-)configuration data from the resource pool or PC5-RRC, determining, by the UE-B, a payload size of the stage 2 SCI based on the determined number of N combinations, and decoding, by the UE-B, inter-UE coordination (IUC) message comprising stage 2 SCI based on the determined payload size.

Other aspects include apparatuses, systems, and computer programs for performing the actions of the aforementioned operations.

The innovative method can include other optional features. For example, in some implementations, the received data further comprises stage 1 SCI. In such implementations, the method can further include decoding, by the UE-B, the received stage 1 SCI.

In some implementations, the decoded stage 1 SCI can indicate a format of the stage 2 SCI.

In some implementations, the determined number of N combinations of TRIV, FRIV, and periodicity in the stage 2 SCI is the actual number of N combinations of TRIV, FRIV, and periodicity.

In some implementations, the IUC can further include data that separately indicates a first resource location of each TRIV.

In some implementations, the data that separately indicates the first resource location of each TRIV can include data indicating a reference slot that is a predetermined number of slots after a retransmission of the PSCCH/PSSCH carrying the IUC, and data indicating a first resource location of each TRIV with respect to the reference slot.

In some implementations, the predetermined number of slots is a period of time for decoding the IUC.

In some implementations, the stage 2 SCI does not include (i) a HARQ feedback enabled/disabled indicator or (ii) a CSI request field.

In some implementations, the received data is transmitted using PSCCH/PSSCH.

According to another innovative aspect of the present disclosure, another method for coordination of communications between user equipment (UE) is disclosed. In one aspect, the method can include obtaining, by a UE-B, first data corresponding to stage 1 sidelink control information (SCI) transmitted by a UE-A, decoding, by the UE-B, the obtained stage 1 SCI, wherein the decoded stage 1 SCI indicates a triggering condition of IUC transmission, determining, by the UE-B, a payload size of the stage 2 SCI based on the triggering condition, and decoding, by the UE-B, inter-UE coordination (IUC) message comprising stage 2 SCI based on the determined payload size.

Other aspects include apparatuses, systems, and computer programs for performing the actions of the aforementioned operations.

The innovative method can include other optional features. For example, in some implementations, the triggering condition is a one-bit value.

In some implementations, the triggering condition is set to a first value indicating that the IUC transmission is based on an explicit resource request.

In some implementations, the explicit resource request is not associated with a resource reservation period.

In some implementations, the triggering condition is set to a second value indicating that the IUC transmission is not based on a resource request that is not explicit.

In some implementations, the resource request is associated with a resource reservation period.

In some implementations, the decoded stage 1 SCI also indicates a format of stage 2 SCI. In such implementations, determining, by the UE-B, a payload size of the stage 2 SCI further based on the triggering condition can further include determining, by the UE-B, a payload size of the stage 2 SCI based on the (i) the format of the stage 2 SCI and (ii) the triggering condition.

According to another innovative aspect of the present disclosure, a method for transmission of inter-UE coordination (IUC) messages is disclosed. In one aspect, the method can include determining, by a UE-A, that an IUC is to be transmitted to a UE-B, selecting, by the UE-A, resources to be used to transmit IUC, wherein the resources are selected based on one or more parameters that include (i) a priority value for the resource (prio_{TX}), (ii) a number of sub-channels (L_{subch}), (iii) a number of time resources for IUC, (iv) a packet delay budget (PDB), (v) a resource reservation periodicity (P_{RSVP_TX}), and (vi) a ratio of identified candidate resources to available resources, and transmitting, by the UE-A, an IUC to the UE-B based on the selected resources.

Other aspects include apparatuses, systems, and computer programs for performing the actions of the aforementioned operations.

The innovative method can include other optional features. For example, in some implementations, the priority value (prio_{TX}) is (pre-)configured by a resources pool.

In some implementations, the number of sub-channels (L_{subch}) is equal to 1.

In some implementations, the number of time resources for IUC depends on the number of time resources for explicit request, or the number of time resources for the TB to be sent by UE-B, or (pre)configured per resource pool.

In some implementations, the packet delay budget (PDB) is based on a first indicated resources in IUC.

In some implementations, the packet delay budget (PDB) is (pre-)configured by a resource pool or PC5-RRC.

In some implementations, the packet delay budget (PDB) is based on a time window of an explicit request.

In some implementations, the resource reservation periodicity (P_{RSVP_TX}) is 0.

In some implementations, the ratio of identified candidate resources to the total number of resources in resource selection procedure used for generating IUC is separate from the ratio used for resource selection for transmitting other data.

In some implementations, the number of sub-channels in the resource pool and used for IUC transmission is restricted by the resource pool (pre-)configuration.

In some implementations, the restricted number of sub-channels is restricted to only the first X sub-channels or last X sub-channels for IUC transmission, where X is any positive integer greater than 0.

According to another innovative aspect of the present disclosure, a method for encoding inter-UE coordination (IUC) messages is disclosed. In one aspect, the method can include determining, by a UE-A, that an IUC is to be transmitted to a UE-B, determining, by the UE-A, an encoding parameter for (i) data of a first transport block comprising sidelink transmission information (TB1) and (ii) data of a second transport block comprising additional data to be transmitted by UE-B on a resource to be selected based on IUC message (TB2), and based on a determination, by the UE-A, that the encoding parameter for TB2 satisfies a predetermined relationship with respect to the encoding parameter for TB1: determining, by the UE-A, to encode TB1 with the IUC for transmission to the UE-B, encoding, by the UE-A, the TB1 with the IUC for transmission to the UE-B, and transmitting, by the UE-A, the encoded TB1 and IUC to the UE-B.

Other aspects include apparatuses, systems, and computer programs for performing the actions of the aforementioned operations.

The innovative method can include other optional features. For example, in some implementations, the encoding parameter that is associated with of TB1 and TB2 is a data priority.

In some implementations, based on a determination, by the UE-A, that the encoding parameter for TB2 satisfies a predetermined relationship with respect to the encoding parameter for TB1, determining, by the UE-A, to encode TB2 with the IUC for transmission to the UE-B can further include based on a determination, by the UE-A, that the data priority for TB2 is greater than or equal to the data priority for TB1, determining, by the UE-A, to encode TB2 with the IUC for transmission to the UE-B.

In some implementations, the method can further include based on a determination, by the UE-A, that the encoding parameter for TB2 does not satisfy a predetermined relationship with respect to the encoding parameter for TB1, determining, by the UE-A, to transmit the TB1 and the IUC to UE-B in separate transmissions. In some implementations, the encoding parameter that is associated with of TB1 and TB2 is a data priority.

In some implementations, the encoding parameter that is associated with of TB1 and TB2 is a packet delay budget (PDB).

In some implementations, based on a determination, by the UE-A, that the encoding parameter for TB2 satisfies a predetermined relationship with respect to the encoding parameter for TB1, determining, by the UE-A, to encode TB2 with the IUC for transmission to the UE-B can further include based on a determination, by the UE-A, that the PDB for TB2 does not exceed a sum of an offset and TB1's PDB, determining, by the UE-A, to encode TB1 with the IUC for transmission to the UE-B.

In some implementations, TB1 is associated a first priority and TB2 is associated with a second priority. In such implementations, determining, by UE-A, a data priority for the encoded TB1 and IUC transmission, wherein the determined data priority for the encoded TB1 and IUC transmission is selected from one of the first priority or the second priority. In some implementations, the UE-A selects the higher priority of the first priority and the second priority.

According to another innovative aspect of the present disclosure, a method for resource selection by user equipment (UE) is disclosed. In one aspect, the method can include receiving, by UE-B, a first inter-UE coordination (IUC) message transmitted by a first UE-A, wherein the first IUC identifies a first resource set (RS), receiving, by the UE-B, a second IUC message transmitted by a second UE-A, wherein the second IUC identifies a second RS, and generating, by the UE-B, a combined resource set based on the first RS identified by the first received IUC and the second RS identified by the second received IUC.

Other aspects include apparatuses, systems, and computer programs for performing the actions of the aforementioned operations.

The innovative method can include other optional features. For example, in some implementations, the method can further include using, by the UE-B, the combined resource set for UE-B's resource selection.

In some implementations, the first RS and the second RS include non-preferred resources. In such implementations, generating, by the UE-B, a resource set based on the first received IUC and the second received IUC can include generating, by the UE-B, a combined resource set based on a union between the first RS and the second RS.

In some implementations, the first RS and the second RS include preferred resources. In such implementations, generating, by the UE-B, a resource set based on the first received IUC and the second received IUC can include generating, by the UE-B, a combined resource set based on a union between the first RS and the second RS.

In some implementations, the first RS and the second RS include preferred resources. In such implementations, generating, by the UE-B, a resource set based on the first received IUC and the second received IUC can include generating, by the UE-B, a combined resource set by selecting one of the first RS or the second RS.

In some implementations, the first RS and the second RS include preferred resources. In such implementations, generating, by the UE-B, a resource set based on the first received IUC and the second received IUC can include generating, by the UE-B, a combined resource set by taking an intersection of the first RS and the second RS.

In some implementations, generating, by the UE-B, a resource set based on the first received IUC and the second received IUC can include generating, by the UE-B, a combined resource set based on the first RS and the second RS based on (pre-)configuration of the UE-B.

In some implementations, the first RS and the second RS collectively include preferred resources and non-preferred resources. In such implementations, the method can further include updating, by the UE-B, the set of preferred resources to exclude the non-preferred resources.

According to another innovative aspect of the present disclosure, a method for identifying one or more UEs that are to receive an IUC is disclosed. In one aspect, the method can include receiving, by a first UE-A, data corresponding to a resource reservation for a conflict resource from multiple different UE-Bs, determining, by the first UE-A, whether one or more of the conflicting UE-Bs have capability to receive the IUC, based on a determination that one or more UE-Bs have the capability of receiving the IUC, determining, by the UE-A, whether at least one of the conflicting UE-Bs do not have capability of receiving the IUC, and based on a determination that none of the conflicting UE-Bs do not have the capability of receiving the IUC, transmitting, by the UE-A, the IUC to all UE-Bs based on their associated priority values.

Other aspects include apparatuses, systems, and computer programs for performing the actions of the aforementioned operations.

The innovative method can include other optional features. For example, in some implementations, the method can further include based on a determination that none of the conflicting UE-Bs have the capability of receiving the IUC, determining, by the UE-A, to not transmit the IUC.

In some implementations, based on a determination that some of the conflicting UE-Bs do not have capability of receiving the IUC, transmitting to the IUC to all the conflicting UE-Bs that have the capability of receiving the IUC.

In some implementations, the IUC is PSFCH.

In some implementations, the PSFCH is derived from the slot of the conflict resource.

In some implementations, a determination, by the UE-A, as to whether one or more of the conflicting UE-Bs have the capability to receive the IUC can include determining, by the UE-A and based on data within a stage 1 SCI transmission, whether one or more of the conflicting UE-Bs have the capability to receive the IUC.

In some implementations, the data within the stage 1 SCI transmission can include a reserved bit.

In some implementations, transmitting, by the UE-A, the IUC to all UE-Bs based on their associated priority values can include transmitting, by the UE-A, the IUC to all UE-As that do not have the lowest priority value.

In some implementations, a method for identifying one or more UEs that are to receive an inter-UE coordination (IUC) is disclosed. In one aspect, the method can include receiving, by UE-A, data corresponding to a resource reservation for a conflict resource from multiple different UE-Bs, transmitting, by the UE-A, IUC to all of the multiple different UE-Bs, which sends SCI to reserve conflict resources in a later slot, having capability to receive IUC, determining, by the UE-A, whether more than one candidate UE-B sent SCI in a same earliest slot, based on a determination, by the UE-A, that more than one of the candidate UE-Bs sent SCI in the same earliest slot, determining, by the UE-A, whether all of the more than one candidate UE-Bs that sent SCI in the same earliest slot have the capability of receiving IUC, and based on a determination that all of the more than one candidate UE-Bs that sent the SCI in the same earliest slot have the capability of receiving IUC, transmitting, by the UE-A, IUC to all of the more than one candidate UE-Bs that sent the SCI in the same earliest slot based on their associated priority values.

Other aspects includes apparatuses, systems, and computer programs for performing the actions of the aforementioned operations.

The innovative method can include other optional features. For example, in some implementations, transmitting, by the UE-A, IUC to all of the more than one candidate UE-Bs that sent the SCI in the same earliest slot based on their associated priority values can include transmitting, by the UE-A, IUC to all of the more than one candidate UE-Bs that sent the SCI in the same earliest slot that do not have the lowest priority value.

In some implementations, the method can further include based on a determination, by the UE-A, that at least one of the more than one of the candidate UE-Bs sent SCI in the same earliest slot do not have the capability of receiving IUC, transmitting, by the UE-A, IUC to all of the candidate UE-Bs having capability to receive the IUC.

In some implementations, based on a determination, by the UE-A, that only one of the candidate UE-Bs sent SCI in the earliest slot, then selecting the candidate UE-B as UE-B.

In some implementations, receiving, by UE-A, data corresponding to a resource reservation for a conflict resource from multiple different UEs can include receiving, by the UE-A, the resource pool (pre-)configuration where PSFCH with IUC is derived from a slot of SCI reserving conflict resource, and receiving multiple UEs resource reservation with conflict.

According to another innovative aspect of the present disclosure, a method for prioritization of physical sidelink feedback channel (PSFCH) transmissions with inter-UE coordination (IUC) messages is disclosed. In one aspect, the method can include determining, by the UE, that an IUC transmission is to be made using PSFCH, the IUC transmission having a first data priority, determining, by the UE, that an IUC reception is to occur simultaneously using the PSFCH with the IUC transmission, the IUC reception having a second data priority, and selecting, by the UE, to execute the IUC transmission or the IUC reception based on the first data priority and the second data priority.

Other aspects includes apparatuses, systems, and computer programs for performing the actions of the aforementioned operations.

The innovative method can include other optional features. For example, in some implementations, selecting, by the UE, to execute the IUC transmission or the IUC reception based on the first data priority and the second data priority can further include: determining, by the UE, that the first data priority is greater than the second data priority, and based on a determination, by the UE, that the first data priority is greater than the second data priority, executing, by the UE, the IUC transmission.

In some implementations, selecting, by the UE, to execute the IUC transmission or the IUC reception based on the first data priority and the second data priority can further include: determining, by the UE, that the second data priority is greater than the first data priority value, and based on a determination, by the UE, that the second data priority is greater than the first data priority value, executing, by the UE, the IUC reception.

In some implementations, selecting, by the UE, to execute the IUC transmission or the IUC reception based on the first data priority and the second data priority can further include determining, by the UE, that the second data priority is greater than the first data priority value, and based on a determination, by the UE, that the second data priority is greater than the first data priority value, selecting, by the UE, only one of the IUC transmission or IUC reception for execution.

According to another innovative aspect of the present disclosure, a method for prioritization of physical sidelink feedback channel (PSFCH) transmissions with inter-UE coordination (IUC) messages is disclosed. In one aspect, the method can include determining, by the UE-A, that a first IUC is to be received using PSFCH, determining, by the UE-A, that a second IUC is to be transmitted using PSFCH, resolving, by the UE-A, conflict between the first IUC that is to be received and the second IUC is to be transmitted, wherein resolving the conflict comprises determining, by the UE-A, to receive the first IUC transmission, and receiving, by the UE-A, the first IUC transmission.

Other aspects includes apparatuses, systems, and computer programs for performing the actions of the aforementioned operations.

According to another innovative aspect of the present disclosure, a method for prioritization of physical sidelink feedback channel (PSFCH) transmissions with inter-UE coordination (IUC) messages is disclosed. In one aspect, the method can include actions of determining, by the UE-A, that an IUC transmission is to be made, the IUC transmission having a first data priority, determining, by the UE-A, that an IUC reception is to be made simultaneously with the IUC transmission, the IUC reception having a second data priority, and resolving, by the UE-A, conflict between the IUC transmission and the IUC reception based on resource pool (pre-)configuration.

Other aspects includes apparatuses, systems, and computer programs for performing the actions of the aforementioned operations.

The innovative method can include other optional features. For example, in some implementations, resolving, by the UE-A, conflict between the IUC transmission and the IUC reception based on resource pool (pre-)configuration can include selecting, by the UE-A and based on the resource pool (pre-)configuration, receipt of the IUC message.

In some implementations, resolving, by the UE-A, conflict between the IUC transmission and the IUC reception based on resource pool (pre-)configuration can include selecting, by the UE-A, to execute the IUC transmission or the IUC reception based on the first data priority and the second data priority.

In some implementations, selecting, by the UE-A, to execute the IUC transmission or the IUC reception based on the first data priority and the second data priority can further include determining, by the UE-A, that the first data priority is greater than the second data priority, and based on a determination, by the UE-A, that the first data priority is greater than the second data priority, executing, by the UE-A, the IUC transmission.

In some implementations, selecting, by the UE-A, to execute the IUC transmission or the IUC reception based on the first data priority and the second data priority can further include determining, by the UE-A, that the second data priority is greater than the first data priority, and based on a determination, by the UE-A, that the second data priority is greater than the first data priority, executing, by the UE-A, the IUC reception.

These and other innovative aspects of the present disclosure are described in more detail herein in the detailed description, the accompanying drawings, and the claims.

### BRIEF DESCRIPTION OF THE DRAWINGS

FIG. 1 is a flowchart of a process for coordination of communications between user equipment (UE).

FIG. 1A is another flowchart of a process for coordination of communications between user equipment (UE) where an indication of N is in stage 1 SCI.

FIG. 1B is another flowchart of a process for coordination of communications between user equipment (UE) where an indication of N is in stage 2 SCI with N_{MAX} as (pre-)configured.

FIG. 1C is another flowchart of a process for coordination of communications between user equipment (UE) where an indication of N is (pre-)configuration data from a resource pool or PC5-RRC.

FIG. 2 is another flowchart of another process for coordination of communications between user equipment (UE) using a triggering condition.

FIG. 3 is a flowchart of a process for identifying a UE-B that is to receive an IUC.

FIG. 3A is a flowchart of another process for identifying a UE-B that is to receive an IUC.

FIG. 4 is a flowchart of another process for identifying a UE-B that is to receive an IUC.

FIG. 4A is a flowchart of another process for identifying a UE-B that is to receive an IUC.

FIG. 5 is flowchart of a process for transmitting an inter-UE coordination (IUC) message by UE-A.

FIG. 6 is a flowchart of a process for encoding an inter-UE coordination (IUC) message by UE-A.

FIG. 7 is a flowchart of a process for generating a combined resource set by a UE-B based on UE-B's receipt of multiple IUC messages.

FIG. 8 is a flowchart of a process for prioritizing IUC transmission in PSFCH.

FIG. 9 is another flowchart of a process for prioritizing IUC transmission in PSFCH.

FIG. 10 is another flowchart of a process for prioritizing IUC transmission in PSFCH.

FIG. 11 is a block diagram of an example device architecture, according to some implementations of the present disclosure.

FIG. 12 illustrates an example of a wireless communication system, according to some implementations of the present disclosure.

FIG. 13 illustrates an example of infrastructure equipment, according to some implementations of the present disclosure.

FIG. 14 illustrates example components of baseband circuitry and radio front end modules (RFEM), according to some implementations of the present disclosure.

FIG. 15 is a block diagram illustrating components able to read instructions from a machine-readable or computer-readable medium (e.g., a non-transitory machine-readable storage medium) and perform any one or more of the methodologies discussed herein, according to some implementations of the present disclosure.

Like reference symbols in the various drawings indicate like elements.

### DETAILED DESCRIPTION

The present disclosure relates to systems, apparatuses, methods, and computer programs for coordination of between user equipment (UE). The present disclosure can be employed to manage and resolve resource conflicts that arise when multiple UE's request the same resource in a resource pool. The present disclosure achieves this by specifying the contents and containers of a transmitting user equipment's (UE-A's) inter-UE coordination information, specifying how determination of one or more destination user equipments (UE-Bs) for UE-A's inter-UE coordination information occurs, by specifying behavior of UE-B(s) receiving resource set(s) from UE-A(s), by specifying the prioritization rule of inter-UE coordination information transmission and reception, by specifying the multiplexing of the inter-UE coordination with sidelink data transmission, and by specifying how to determine UE-B among Us scheduling conflicting TBs including the case when at least one of the UEs scheduling conflicting TBs doesn't support Scheme 2.

These features of the present disclosure enable inter-UE coordination that does can use stage 2 SCI for inter-UE coordination in addition to the use of MAC-CE. This improves performance, e.g., reducing latency required for inter-UE coordination. These and other technical advantages will become apparent for the disclosure of the innovative aspects of the present disclosure set forth herein.

### SCI Stage 2 for Inter-UE Coordination

In some implementations, the present disclosure describes a new design for stage 2 SCI. The contents of the newly designed stage 2 SCI for inter-UE coordination using scheme 1 is described herein, as well as a process UE-B behavior upon obtaining stage 1 SCI information.

In one aspect, the present disclosure can determine a Number of N combinations of (TRIV, FRIV, periodicity) to use in the SCI stage 2. In some implementations, the number of N is (pre-)configured per resource pool or PC5-RRC. In some implementations, the number of Nis dynamically indicated in SCI stage 1. In some implementations, the number of N is dynamically indicated in SCI stage 2, where the maximum of N_max is (pre)configured per resource pool or may be fixed (pre-defined). In some implementations, N can refer configured table entry index.

In some implementations, the number of N should not be larger than 3, considering the payload size limitation of SCI stage 2. N can be directly indicated between 1, 2 and 3. In some implementations, 2 bits can be used to indicate N=1, 2 or 3. In other implementations, 1 bit can be used to indicate N=1 or 2.

In some implementations, decoding of SCI stage 2 can be based on the (pre-)configured or pre-defined N_max value. UE-B may selectively use the actual N number of combinations.

In some implementations, a first resource location of each TRIV is separately indicated by the inter-UE coordination information. First, a reference slot is determined as being X slots after the last or first retransmission of the PSCCH/PSSCH carrying IUC, where X is any integer number of slots greater than 0. In some implementations, a determination between the first or the last retransmission of PSCCH/PSSCH carrying IUC may depend on resource pool (pre-)configuration. In some implementations, X can cover the processing timeline of decoding of IUC message, resource selection and preparation of the SL transmissions. In some implementations, X can be pre-defined, e.g., with value greater than or equal to T_{proc,0}+T_{proc,1·}T_{proc,0} is the processing time of sensing results. T_{proc,1} is the preparation time of sideline data transmission. In yet other implementations, X can be (pre-)configured by resource pool or by PC5-RRC.

Then, a first resource location of each TRIV is indicated on top of reference slot. Y is indicated in SCI stage 2 for the first resource location of each TRIV, where Y is any integer number of slots that is greater than 0. In some implementations, a direct indication of Y slots can be made. In other implementations, configured table based indication of Y slots can be used.

X and Y are, therefore, a number of logical slots. Accordingly, the first resource location of the TRIV is X+Y slots after the last or first IUC retransmission.

The number of bits A_{y} to indicate the value of Y may be (pre-)configured per resource pool. A_{y} can be less than or equal to 5 bits. The value of A_{y} may be (pre-)configured per resource pool or PC5-RRC.

Accordingly, in the some implementations, the IUC of process 100 can include data that separately indicates a first resource location of each TRIV. In some implementations, the data that separately indicates the first resource location of each TRIV can include (i) data indicating a reference slot that is a predetermined number of slots after a retransmission of the PSCCH/PSSCH carrying the IUC and (ii) data indicating a first resource location of each TRIV with respect to the reference slot. In such implementations, the predetermined number of slots is a period of time for decoding the IUC

In some implementations, there is no requirement or need of feedback for IUC transmissions. Accordingly, in some implementations, SCI stage 2 (new format) does not include a “HARQ feedback enabled/disabled indicator” field or a “CSI request” field.

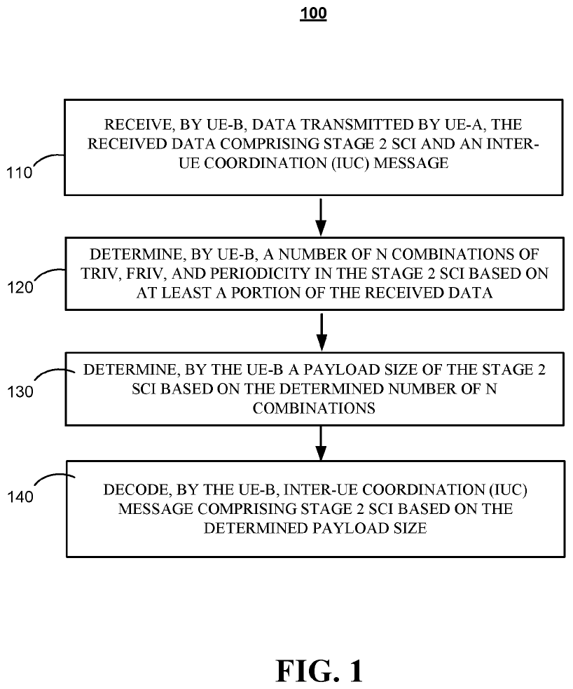

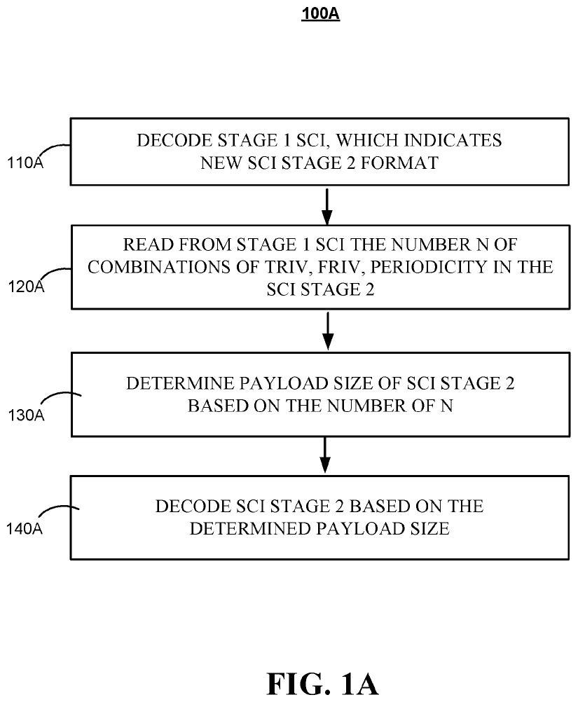

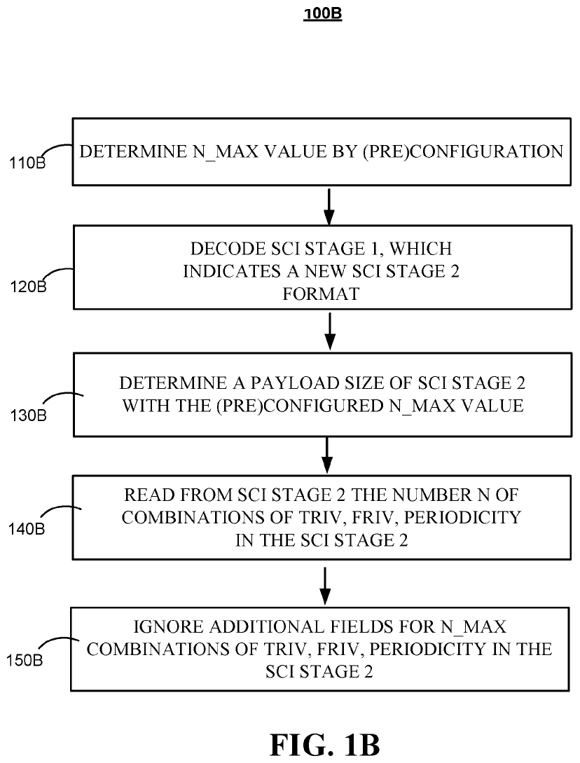

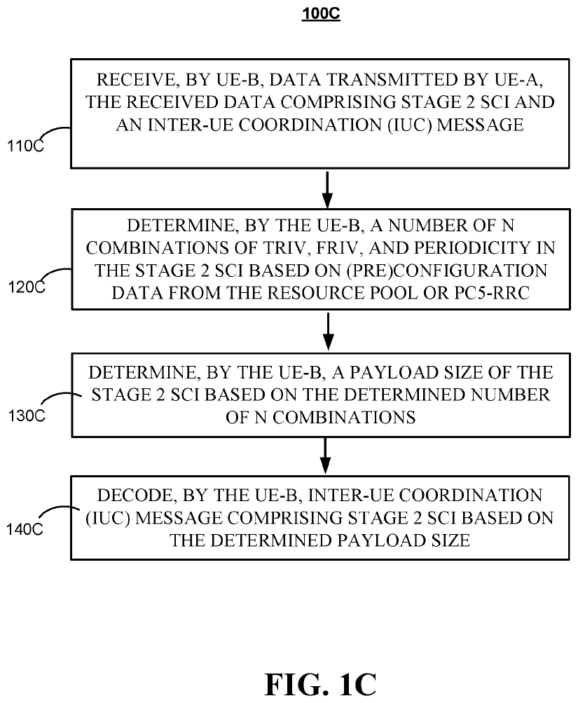

FIG. 1 is a flowchart of a process 100 for coordination of communications between user equipment (UE). For convenience, the process 100 will be described as being performed by a transmitting UE such as UE-B. For purposes of this specification, notation such as UE-A or UE-B may be used. In general, UE-A is used to refer to UEs that transmit IUC messages and UE-B is used to refer to UEs that receive IUC messages. However, any UE device can be either a UE-A or UE-B based on its current role in a process flow (i.e., whether the UE is transmitting or receiving IUC).

UE-B can begin execution of the process 100 by receiving 110 data transmitted by a UE-A. The received data can include stage 2 sideline control information (SCI) and an inter-UE coordination (IUC) message. In some implementations, the received data can also include stage 1 SCI. In some implementations, the UE-A is user equipment that transmitted the received data using PSCCH/PSSCH, and the UE-B is user equipment that received the received data that was transmitted by the UE-A using PSCCH/PSSCH.

The UE-B can continue execution of the process 100 by determining 120 a number of N combinations of time resource indicator value (TRIV), frequency resource indicator value (FRIV), and periodicity in the stage 2 SCI based on at least a portion of the data received at stage 110. The UE-B can determine N in a number of different ways.

In some implementations, the UE-B can determine the number of N combinations of TRIV, FRIV, and periodicity in the stage 2 SCI based on information received in the stage 1 SCI, wherein N is any positive integer greater than 0. In such implementations, for example, the UE-B can decode the received stage 1 SCI, and then the UE-B can obtain, from the decoded stage 1 SCI, second data corresponding to the format of the stage 2 SCI. This second data corresponding to the format of the stage 2 SCI can include a number of N combinations of TRIV, FRIV, and periodicity in the SCI stage 2. In some implementations, the second data obtained from the decoded stage 1 SCI can be data that refers to a configured table entry index. In such implementations, an entry of a configured table indexed by the obtained index can indicate the number of N combinations of TRIV, FRIV, and periodicity in stage 2 SCI.

In other implementations, the UE-B can determine the number of N combinations of TRIV, FRIV, and periodicity in the stage 2 SCI based on information received in the stage 2 SCI. In such implementations, for example, the UE-B can decode the received stage 2 SCI, and then the UE-B can obtain, from the decoded stage 2 SCI, second data corresponding to a number of a number of N combinations of TRIV, FRIV, and periodicity in stage 2 SCI.

In some implementations, the number of N combinations of TRIV, FRIV, and periodicity obtained from the stage 2 SCI is no more than a maximum number of N combinations of TRIV, FRIV, and periodicity. In such implementations, the maximum number of N combinations of TRIV, FRIV, and periodicity can be (pre-)configured based on a resource pool utilized by the UE-A and the UE-B.

In yet other implementations, the maximum number of N combinations of TRIV, FRIV, and periodicity is a (pre-)configured based on a fixed value for the maximum number of N combinations of TRIV, FRIV, and periodicity.

In yet other implementations, the determined number of N combinations of TRIV, FRIV, and periodicity in the stage 2 SCI in any of the preceding implementations can be the actual number of N combinations of TRIV, FRIV, and periodicity.

In any of the preceding implementations, the number of N combinations of TRIV, FRIV, and periodicity can be less than or equal to 3. In such implementations, the number of N combinations of TRIV, FRIV, and periodicity can be indicated using 2 bits of the stage 2 SCI.

However, in other instances and in either of the preceding implementations, the number of N combinations of TRIV, FRIV, and periodicity is less than or equal to 2. In such implementations, the number of N combinations of TRIV, FRIV, and periodicity is indicated using 1 bit of the stage 2 SCI.

The UE-B can continue execution of the process 100 by determining 130 a payload size of the stage 2 SCI based on the determined number of N combinations. For example, in some implementations, UE-B knows the payload size of each combination of TRIV, FRIV, periodicity. In some implementations, for example, UE-B can know that each particular combination of TRIV, FRIV, and periodicity has, e.g., W bits. Then, once UE-B determines the number of N combinations of TRIV, FRIV, and periodicity, UE-B can calculate the payload size of N combinations of TRIV, FRIV, and periodicity has having N*W bits. Subsequently, the payload size of stage 2 SCI is ((N*W)+Z) bits, where Z is the payload size of other fields in stage 2 SCI. In some implementations, UE-B can determine a payload size of the stage 2 SCI based on a number of N combinations obtained from the decoded stage 1 SCI or decoded stage 2 SCI. In other implementations, UE-B can determine a payload size of the stage 2 SCI based on a (pre-)configured maximum number of N combinations of TRIV, FRIV, and periodicity. In other implementations, UE-B can determine a payload size of the stage 2 SCI based on an actual number of N combinations of TRIV, FRIV, and periodicity.

UE-B can continue execution of the process 100 by decoding 140 inter-UE coordination (IUC) message comprising stage 2 SCI based on the determined payload size. In some implementations, decoding the IUC message comprising stage 2 SCI can include disregarding additional fields for the maximum number of N combinations of TRIV, FRIV, and periodicity in the stage 2 SCI.

In this regard, the maximum number of N combinations can be used to determine the payload size of SCI stage 2. However, in each IUC transmission, the actual number of N combinations may be less than the maximum number. For example, in some implementations, the maximum number is 3 based on (pre)configuration. However, in such implementations, each combination of TRIV, FRIV, periodicity may use 20 bits. Then, it is assumed that SCI stage 2 has 60 bits (=3*20) plus additional offset bits (e.g., bits to indicate the actual number of combinations, etc).

Continuing with this example, after UE-B decodes the SCI stage 2, assuming (60+offset) information bits, the UE-B can determine (from the offset bits) that this IUC actually only contains 1 combination of (TRIV, FRIV, periodicity). In such instances, the UE-B can ignore the last 40 bits (=2*20) additional fields/information of its decoded SCI stage 2 information bits. Accordingly, in this example, the “additional fields” is equal to the difference between the maximum number of combinations and the actual number of combinations.

In some implementations, IUC messages, such as the IUC message of any process described herein, can include data that separately indicates a first resource location of each TRIV. In some implementations, this data can indicate a reference slot that is a predetermined number of X slots after a (re)transmission of the PSCCH/PSSCH carrying the IUC. In such instances, the predetermined number of slots is a period of time for decoding the IUC. In addition, the IUC can also have data indicating a first resource location Y of each TRIV with respect to the reference slot.

In some implementations of the process 100, the stage 2 SCI does not include (i) a HARQ feedback enabled/disabled indicator or (ii) a CSI request field.

FIG. 1A is another flowchart of a process 100A for coordination of communications between user equipment (UE) where an indication of N is in stage 1 SCI. The process 100A will be described as being performed by a UE, such as UE-B.

UE-B can begin performance of the process 100A by decoding 110A stage 1 SCI data. In such implementations, the decoded stage 1 SCI data can include data that indicates stage 2 SCI format. UE-B can continue performance of the process 100A by reading 120A from the decoded stage 1 SCI data the number N of combinations of TRIV, FRIV, and periodicity in the stage 2 SCI. UE-B can continue performance of the process 100A by determining 130A payload size of stage 2 SCI based on the number of N combinations determined at stage 120A. UE-B can continue performance of the process 100A by decoding stage 2 SCI based on the determined

FIG. 1B is another flowchart of a process 100B for coordination of communications between user equipment (UE) where an indication of N is in stage 2 SCI with N_{MAX} as (pre-configured. The process 100B will be described as being performed by a UE, such as UE-B.

UE-B can begin performance of the process 100B by determining 110B an N_Max value determined by (pre-)configuration. (Pre-)configuration, as used herein, is intended to mean pre-configuration or configuration. The N-Max value can include a maximum number of N combinations of TRIV, FRIV, and periodicity of stage 2 SCI.

UE-B can continue performance of the process 100B by decoding 120B stage 1 SCI data. In such implementations, the decoded stage 1 SCI data can include data that indicates stage 2 SCI format. UE-B can continue execution of the process 100B by determining 130B a payload size of stage 2 SCI using the (pre-)configured N_Max value. UE-B can continue performance of the process 100B by reading, from stage 2 SCI, the number N of combinations of TRIV, FRIV, and periodicity in the stage 2 SCI. The number N of combinations of TRIV, FRIV, and periodicity read at stage 140B can include the actual number of N combinations of TRIV, FRIV, and periodicity in the stage 2 SCI. The UE-B can continue performance of the process 100B by ignoring additional fields for N_Max combinations of TRIV, FRIV, and periodicity in the stage 2 SCI. In some implementations, the ignored additional fields can include the difference between N-Max and the actual number N, as described above.

FIG. 1C is another flowchart of a process for coordination of communications between user equipment (UE) where an indication of N is (pre-)configuration data from a resource pool or PC5-RRC. The process 100C will be described as being performed by a UE, such as UE-B.

UE-B can begin execution of the process 100C by receiving 110C data transmitted by UE-A. The received data can include stage 2 sidelink control information (SCI) and an inter-UE coordination (IUC) message. In some implementations, the received data can also include stage 1 SCI

UE-B can continue performance of the process 100C by determining 120C a number of N combinations of TRIV, FRIV, and periodicity in the stage 2 SCI based on (pre-)configuration data from the resource pool or PC5-RRC. In some implementations, UE-B can determine the number N of combinations of TRIV, FRIV, and periodicity in the stage 2 SCI by decoding, by the UE-B, the received stage 1 SCI and obtaining data from the stage 1 SCI that indicates the format of the stage 2 SCI. Such data indicating the format of the stage 2 SCI can include.

UE-B can continue execution of the process 100C by determining a payload size of the stage 2 SCI based on the determined number of N combinations. UE-B can continue execution of the process 100C by decoding the inter-UE coordination (IUC) message comprising stage 2 SCI based on the determined payload size.

### Indication of Triggering Condition (1-Bit)

In some implementations, the stage 1 SCI can include an indication of a triggering condition. The indication of a triggering condition can indicate whether or not the IUC transmission is based on explicit request. Of the IUC is triggered by explicit request, then the resource reservation period is not indicated in the IUC. Otherwise, the resource reservation period is indicated.

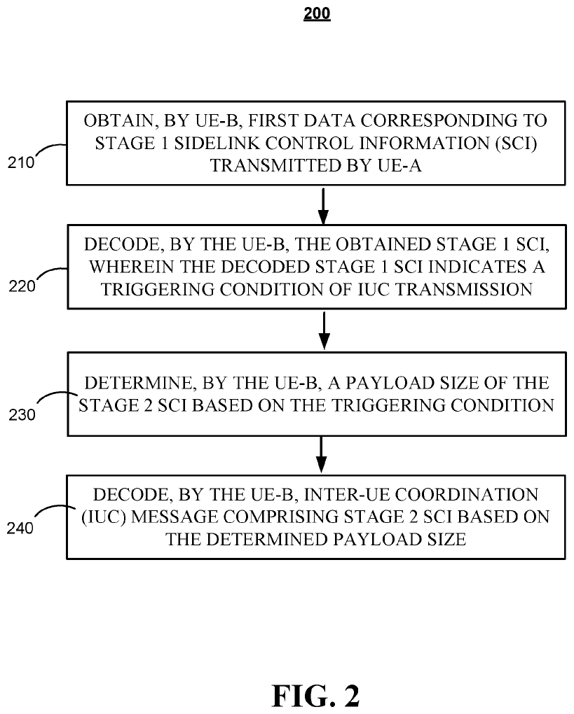

FIG. 2 is another flowchart of another process 200 for coordination of communications between user equipment (UE) using a triggering condition. The process will be described below as being performed by a UE, such as UE-B.

UE-B can begin performance of the process 200 by obtaining 210 first data corresponding to stage 1 sidelink control information (SCI) transmitted by a UE-A. UE-B can continue execution of the process 200 by decoding the obtained stage 1 SCI, wherein the decoded stage 1 SCI indicates a triggering condition of IUC transmission. In some implementations, the triggering condition can be implemented using a one-bit value. The one-bit triggering value can be used to indicate whether or not the IUC transmission is based on an explicit request. For example, a one-bit value of “0” may indicate that IUC was triggered by explicit request and a one-bit value of “1” may indicate that the IUC was not triggered by explicit request, or vice versa.

If IUC is triggered by explicit request, the IUC is not associated with a resource reservation period. However, if IUC is not triggered by explicit request, then the IUC is associated with a resource reservation period.

In some implementations, the decoded stage 1 SCI 1 can also include data that indicates a format of the stage 2 SCI. For example, the decoded stage 1 SCI can include data indicating a number N of combinations of TRIV, FRIV, and periodicity for stage 2 SCI.

UE-B can continue execution of the process 200 by determining a payload size of the stage 2 SCI based on the triggering condition. In some implementations, determining, by the UE-B, a payload size of the stage 2 SCI can be achieved based on the (i) the format of the stage 2 SCI, (ii) the triggering condition, or both.

UE-B can continue execution of the process 200 by decoding inter-UE coordination (IUC) message comprising stage 2 SCI based on the determined payload size.

### Procedure to Determine Receiving UE (i.e., UE-B)

With respect to condition 2-A-1 (conflict based) in Scheme 2 and for each pair of UEs scheduling the conflicting TBs, a UE with the higher priority value is UE-B.

In some implementations, an additional condition for UE-A to send PSFCH to a UE-B can be employed. The IUC scheme 2 occasion is derived from the slot of conflict resource. All the UEs scheduling the conflicting TBs have the capability of receiving IUC (or expect to receive IUC). In some implementations, this is indicated by SCI stage 1 (e.g., using a reserved bit).

UE-A sends PSFCH to all UEs without the lowest priority value (i.e., without highest priority data). If more than 1 UE has the lowest priority value, then it is UE-A's implementation to determine which UE not to send PSFCH.

In some implementations, if all the UEs scheduling the conflict TBs do not have capability of receiving IUC, then UE-A does not send PSFCH. Alternatively, if at least one UE among the UEs scheduling the conflicting TBs do not have capability of receiving IUC, then UE-A sends PSFCH to all UEs with capability of receiving IUC.

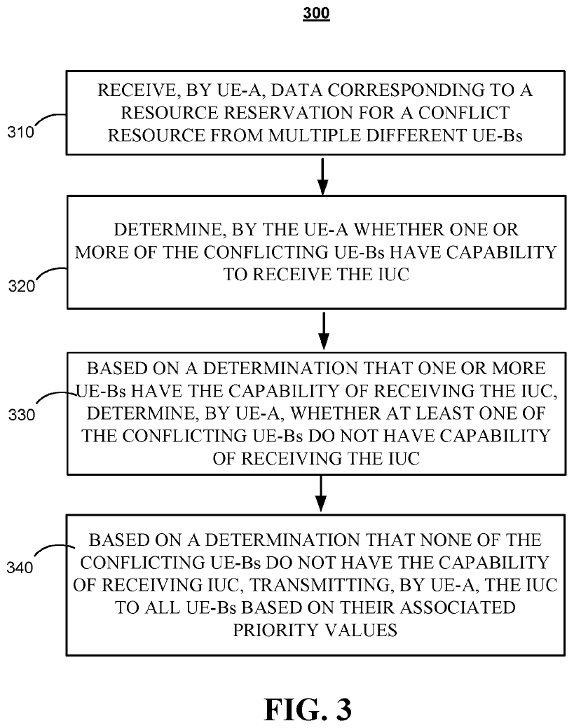

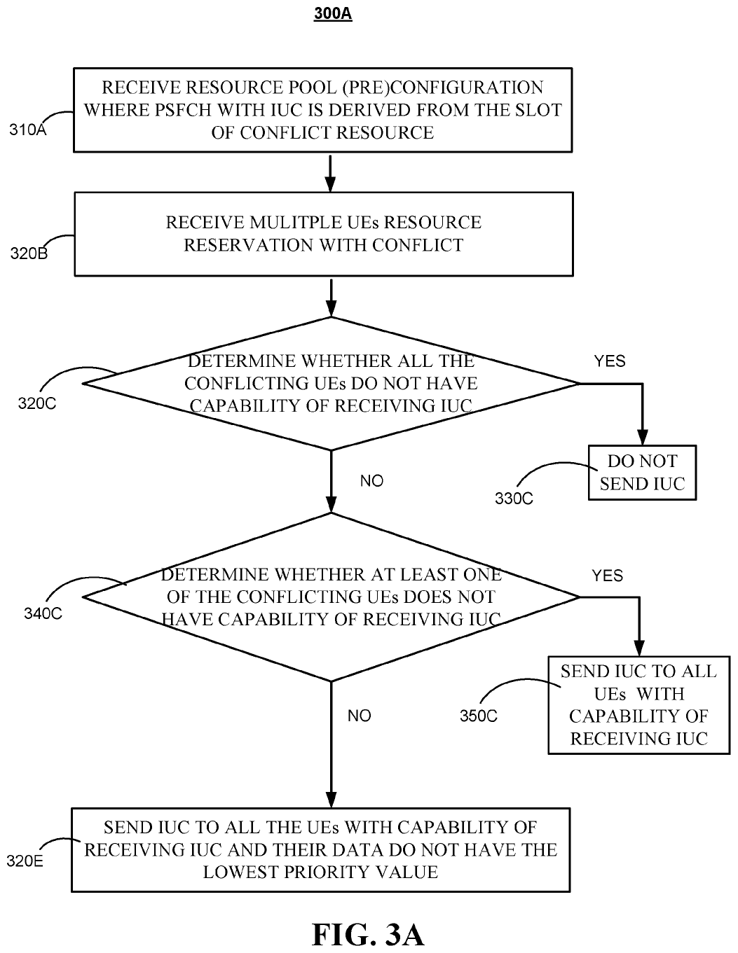

FIG. 3 is a flowchart of a process 300 for identifying a UE-B that is to receive an IUC. The process will be described as being performed by a UE such as UE-A.

UE-A can begin performance of the process 300 by receiving 310 data corresponding to a resource reservation for a conflict resource from multiple different UE-Bs.

UE-A can continue performance of the process 300 by determining 320 whether one or more of the conflicting UE-Bs have capability to receive the IUC. In some implementations, the determination at stage 320 includes the UE-A determining, based on data within a stage 1 SCI transmission, whether one or more of the conflicting UE-Bs have the capability to receive the IUC. In such implementations, the data within the stage 1 SCI transmission comprises a reserved bit.

Based on a determination that one or more UE-Bs have the capability of receiving the IUC, UE-A can continue performance of the process 300 by determining 330 whether at least one of the conflicting UE-Bs do not have capability of receiving the IUC.

Based on a determination that none of the conflicting UE-Bs do not have the capability of receiving the IUC, UE-A can continue performance of the process 300 by transmitting the IUC to all UE-Bs based on their associated priority values. In some implementations, the transmitting of stage 340 can include transmitting the IUC to all UE-As that do not have the lowest priority value. In some implementations, the IUC is transmitted using PSFCH. In such implementations, the PSFCH is derived from the slot of the conflict.

Alternatively, in some implementations, based on a determination, by UE-A, that none of the conflicting UE-Bs have the capability of receiving the IUC, UE-A can continue performance of process 300 by determining to not transmit the IUC.

Alternatively, in some implementations, based on a determination, by UE-A, that some of the conflicting UE-Bs do not have capability of receiving the IUC, the UE-A can continue execution of the process 400 by transmitting to the IUC to all the conflicting UE-Bs that have the capability of receiving the IUC.

FIG. 3A is a flowchart of another process 300A for identifying a UE-B that is to receive an IUC. The process 300A will be described as being performed by a UE such as UE-A.

UE-A can begin performance of the process 300A by receiving 310A resource pool (pre)configuration where PSFCH with IUC is derived from the slot of conflict resource.

UE-A can continue performance of the process 300A by receiving 320B multiple UEs resource reservation with conflict.

UE-A can continue performance of the process 300A by determining 320C whether all conflicting UE-Bs do not have the capability of receiving IUC. Based on a determination that all conflicting UE-Bs do not have the capability of receiving IUC, then UE-A can determine to not send IUC and process 300A can end. Alternatively, UE-A can determine, stage 320C, that at least one of the conflicting UE-Bs has capability of receiving IUC. In such instances, UE-A can continue execution of the process 300A at stage 340C.

At stage 340C, UE-A can determine whether at least one of the conflicting UE-Bs does not have the capability of receiving IUC. Based on a determination, by UE-A, that at least one of the conflicting UE-Bs does not have the capability of receiving IUE, then UE-A can determine to send (or transmit) IUC to all UE-Bs with capability of receiving IUC. After sending of the IUC to all UE-Bs at stage 350c, the process 300A can end. Alternatively, the UE-A can determine, at stage 340C, that all of the conflicting UEs can receive IUC. In such instances, UE-A can continue execution of process 300A at stage 320E by sending (or transmitting) an IUC message to all the UE-Bs with (i) capability of receiving IUC messages and (ii) their data do not have the lowest priority value. After sending of the IUC messages at stage 320, the process 300A can end.

For Condition 2-A-1 (conflict based) in Scheme 2, for each pair of UEs scheduling the conflicting TBs, if the resource pool (pre-)configures that the PSFCH with IUC is derived from the slot of SCI reserving conflict resource, then a UE which sends SCI (to reserve conflict resources) in a later slot is UE-B.

In other implementations, if any of the UEs, sending SCI (to reserve conflict resources) in a later slot, does not have capability of receiving IUC, then UE-A does not send PSFCH to that particular UE.

If more than one UE sending SCI (to reserve conflict resources) in the same earliest slot, the UE-A then determines if at least one of the UEs does not have the capability of receiving IUC. If the UE-A determines that at least one of the UEs does not have the capability of receiving IUC, then UE-A sends PSFCH to all the other UEs with the capability of receiving IUC.

However, if the UE-A determines that If all the UEs have the capability of receiving IUC, then UE-A sends PSFCH to all the UEs without the lowest priority value. If more than 1 UE has the lowest priority value, then the UE-A can be configured to determine which UE not to send PSFCH.

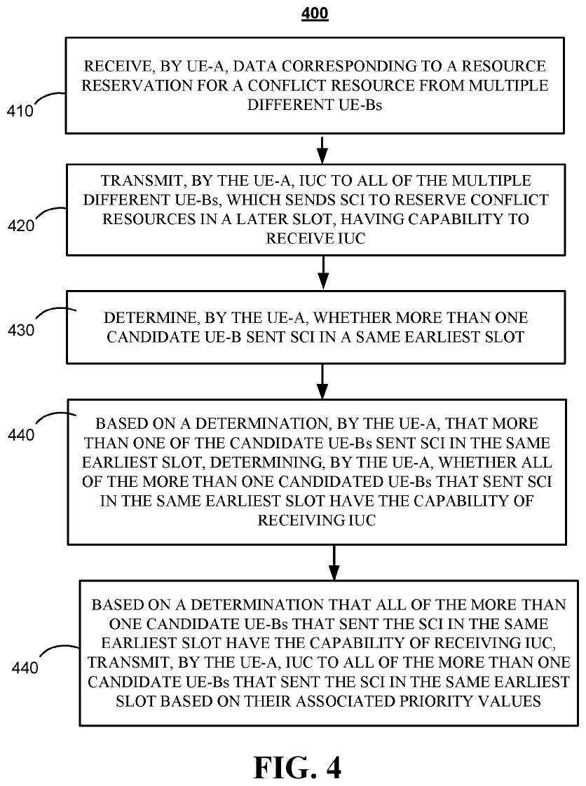

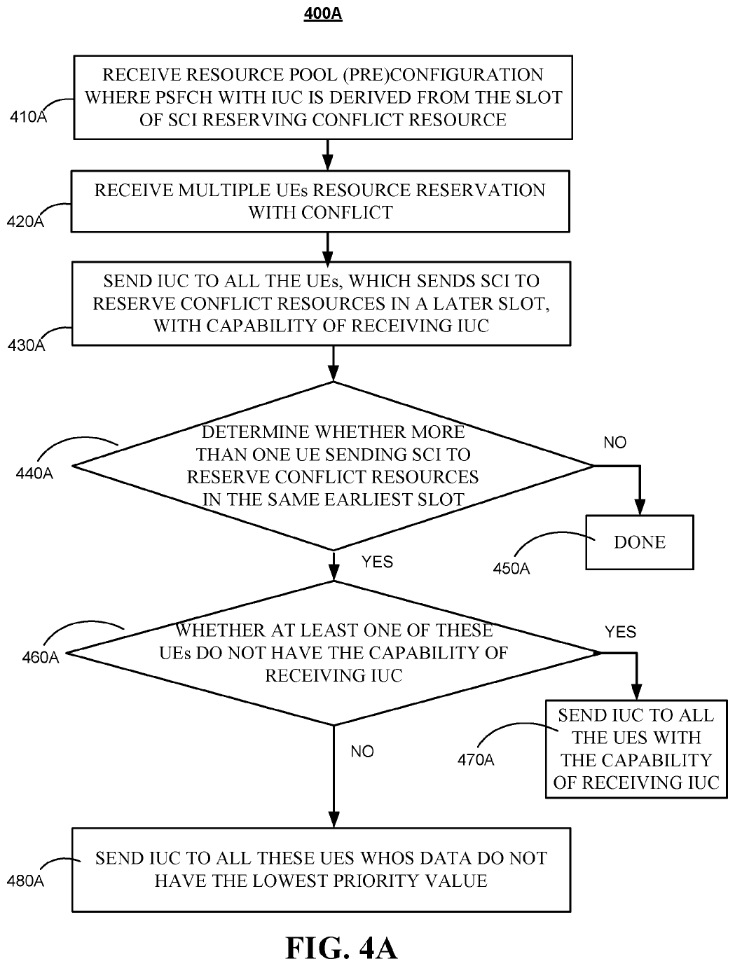

FIG. 4 is a flowchart of another process 400 for identifying a UE-B that is to receive an IUC. The process 400 will be described as being performed by a UE such as UE-A.

UE-A can begin performance of the process 400 by receiving 410 data corresponding to a resource reservation for a conflict resource from multiple different UE-Bs. In some implementations, the receiving operation at stage 410 can include the UE-A receiving the resource pool (pre-)configuration where PSFCH with IUC is derived from a slot of SCI reserving conflict resource and the UE-A receiving multiple UE-Bs resource reservation with conflict.

The UE-A can continue execution of the process 400 by transmitting 420 IUC to all of the multiple different UE-Bs, which sends SCI to reserve conflict resources in a later slot, having capability to receive IUC.

The UE-A can continue execution of the process 400 by determining 430 whether more than one candidate UE-B sent SCI in a same earliest slot. Based on a determination, at stage 430 by the UE-A, that more than one of the candidate UE-Bs sent SCI in the same earliest slot, the UE-can subsequently determine 440 whether all of the more than one candidate UE-Bs that sent SCI in the same earliest slot have the capability of receiving IUC.

Then, based on the subsequent determination at stage 440 that all of the more than one candidate UE-Bs that sent the SCI in the same earliest slot have the capability of receiving IUC, the UE can transmitting 440 IUC to all of the more than one candidate UE-Bs that sent the SCI in the same earliest slot based on their associated priority values. In some implementations, the transmitting IUC based on their associated priority values at stage 440 can include the UE-A transmitting to all of the more than one candidate UE-Bs that sent the SCI in the same earliest slot that do not have the lowest priority value.

Alternatively, in some implementations, the UE-A can determine at stage 440 that at least one of the more than one of the candidate UE-Bs sent SCI in the same earliest slot do not have the capability of receiving IUC. In such implementations, the UE-A can transmit IUC to all of the candidate UE-Bs having capability to receive the IUC.

In yet other implementations, the UE-A can determine at stage 430 that only one of the candidate UE-Bs sent SCI in the earliest slot. In such implementations, the UE-A does not send IUC to this candidate UE-B, which is actually not UE-B.

FIG. 4A is a flowchart of another process 400A for identifying a UE-B that is to receive an IUC. The process 400A will be described as being performed by a UE such as UE-A.

UE-A can begin performance of the process 400A by receiving 410A resource pool (pre-)configuration where PSFCH with IUC is derived from the slot of SCI reserving conflict resource.

UE-A can continue performance of the process 400A by receiving 420A multiple UE-Bs resource reservation with conflict.

UE-A can send (or transmit) 430A an IUC message to all the UE-Bs, which send SCI to reserve conflict resources in a later slot, with capability of receiving IUC.

At stage 440A, UE-A can determine whether there is more than one UE-B sending SCI to reserve conflict resources in the same earliest slot. Based on a determination, UE-A at stage 440A, that there is not more than one UE-B sending SCI to reserve conflict resources in the same earliest slot, then UE-A can terminate the process at stage 450A. Alternatively, based on a determination, at stage 440A by UE-A that there is more than one UE-B sending SCI to reserve conflict resources in the same earliest slot, then UE-A can continue execution of the process 400A at stage 460A.

At stage 460A, UE-A can determine whether at least one of these UE-Bs do not have the capability of receiving IUC. If UE-A determinates, at stage 460A, that at least one of these UE-Bs do not have the capability of receiving IUC, then UE-A can continue execution of the process 400A at stage 470A by sending (or transmitting) 470A an IUC message to all the UE-Bs with the capability of receiving IUC. After completion of stage 470A, the process 400A can end. Alternatively, if UE-A determines, at stage 460A, that there is not at least one of the UE-Bs that do not have the capability of receiving IUC, the UE-A can continue execution of the process 400A by sending (or transmitting) 480A IUC to all the UE-Bs whose data does not have the lowest priority value. After completion of stage 480A, the process 400B can end.

### Transmission of Inter-UE Coordination

In some implementations, resources for IUC scheme 1 transmission can be obtained from legacy mode 2 resource selection. A priority value such as priory can be used in resource selection. In some implementations, this can be the same priority value as the priority value in the explicit request. In other implementations, the priority value can be (pre-)configured by resource pool.

In some implementations, the number of sub-channels L_{subch} can be equal to 1. In some implementations, the number of time resources for IUC can depend on (same as) the number of explicit request, or the number of time resources for the TB to be sent by UE-B, or (pre)configured per resource pool.

In some implementations, Packet Delay Budget (PDB) depends on the first indicated resource in the IUC, e.g., can be equal to the first indicated resource in IUC minus some offset. In such implementations, the offset can be used for UE-B's receiving IUC and processing the received IUC. In other implementations, the PDB can be (pre-)configured by resource pool or PC5-RRC. In other implementations, the PDB can depend on the time window of the explicit request.

In some implementations, the resource reservation periodicity (P_{rsvp_TX}): 0. In some implemenations, Cᵣₑₛₑₗ=0.

In some implementations, separate X % value is used for the resource selection for IUC. In such implementations, X % is the percentage of the identified candidate resources over all the candidate resources, which are to be reported to higher layer.

In some implementations, the sub-channels in a resource pool used for IUC transmission can be restricted by resource pool (pre-)configuration. For example, only the first or last X sub-channels could be used for explicit request transmission.

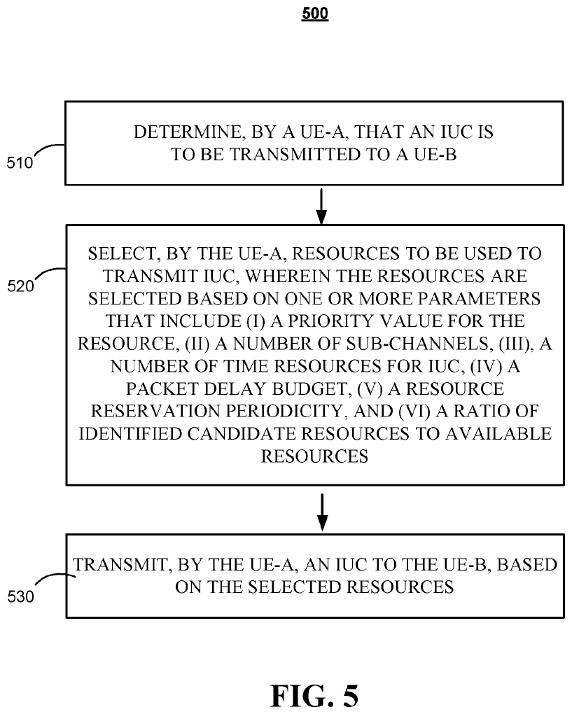

FIG. 5 is flowchart of a process 500 for transmitting an inter-UE coordination (IUC) message by UE-A. The process 500 will be described as being performed by a UE such as UE-A.

UE-A can begin performance of the process 500 by determining 510 that an IUC is to be transmitted to a UE-B.

UE-A can continue execution of the process 500 by selecting 520 resources to be used to transmit the IUC. In such implementations, the UE-A can select the resources to be used to transmit IUC based on one or more parameters that include (i) a priority value for the resource (prio_{TX}), (ii) a number of sub-channels (L_{subch}), (iii) a number of time resources for IUC, (iv) a packet delay budget (PDB), (v) a resource reservation periodicity (P_{RSVP_TX}), and (vi) a ratio of identified candidate resources to available resources.

In some implementations, the priority value (prio_{TX}) is (pre-)configured by a resources pool. In some implementations, the number of sub-channels (L_{subch}) is equal to 1. In some implementations, the number of time resources for IUC depends on the number of time resources for explicit request, the number of time resources for the TB to be sent by UE-B, or (pre)configured per resource pool. In some implementations, the packet delay budget (PDB) is based on a first indicated resources in IUC, e.g., equal to the first indicated resources in IUC minus some offset. In some implementations, the packet delay budget (PDB) is (pre-)configured by a resource pool or PC5-RRC signaling. In some implementations, the packet delay budget (PDB) is based on a time window of an explicit request. In some implementations, a resource reservation periodicity (P_{RSVP_TX}) is 0.

In some implementations, the ratio of identified candidate resources to the total number of resources in resource selection procedure used for generating IUC is separate from the ratio used for resource selection for transmitting other data.

In some implementations, the number of sub-channels in the resource pool and used for IUC transmission is restricted by the resource pool (pre-)configuration.

In some implementations, the restricted number of sub-channels is restricted to only the first X sub-channels or last X sub-channels for IUC transmission, where X is any positive integer greater than 0.

UE-A can continue execution of the process 500 by transmitting 530 an IUC to the UE-B based on the resources selected at stage 520.

### Multiplexing IUC Scheme With Sidelink Transmission

In some implementations, priority of the multiplexed sidelink transmission can be implemented along with an explicit request. Priority values can be associated with the multiplexed sidelink transmission and IUC. In such implementations, the lower priority value of the sidelink transmission and the TB associated with the explicit request that UE-B wants to transmit can be selected.

Criteria of multiplexing can include the following. First, TB1 of the sidelink transmission and TB2 associated with the IUC that UE-B wants to transmit can be used as a multiplexing criteria. In some implementations, TB2's data priority is higher than or equal to TB1's data priority. In other implementations, TB2's PDB is no more than an offset plus TB1's PDB.

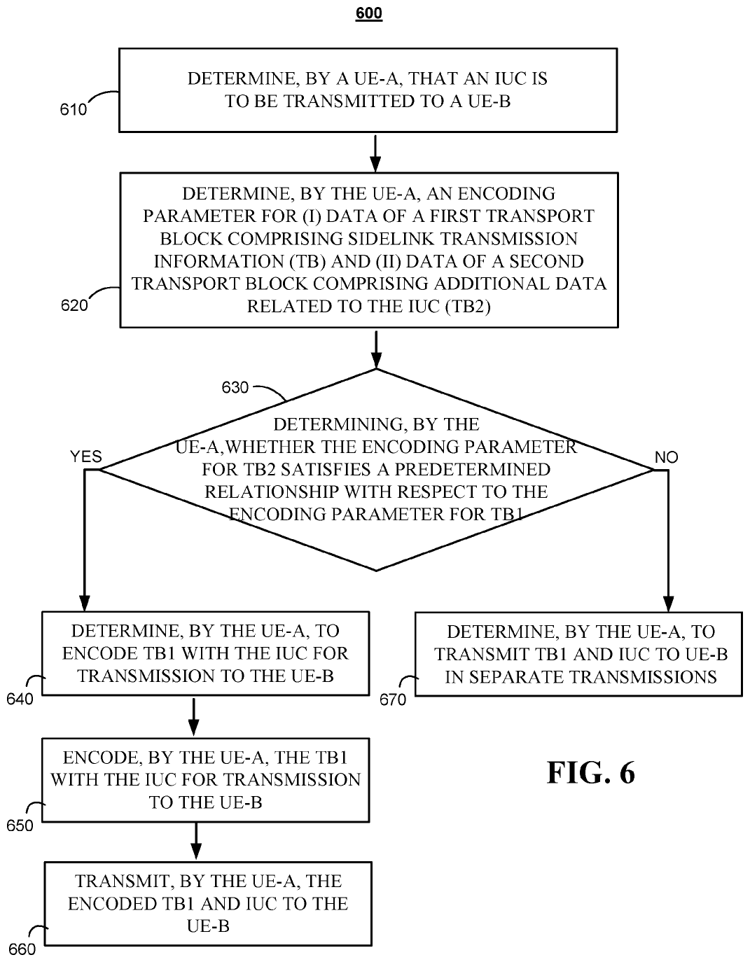

FIG. 6 is a flowchart of a process 600 for encoding an inter-UE coordination (IUC) message by UE-A. The process 600 will be described as being performed by a UE such as UE-A.

UE-A can begin performance of the process 600 by determining 610 that an IUC is to be transmitted to a UE-B.

UE-A can continue performance of the process 600 by determining 620 an encoding parameter for (i) data of a first transport block comprising sidelink transmission information (TB1) and (ii) data of a second transport block comprising additional data to be transmitted by UE-B on a resource to be selected based on IUC message (TB2). A transport block (TB) can include any data that is to be transmitted by a UE. The encoding parameter can be any parameter or parameter value the can be evaluated to determine whether TB1 is to be encoded (or multiplexed) with IUC.

The UE-A can continue performance of the process 600 by determining 630 whether the encoding parameter TB2 satisfies a predetermined relationship with respect to the encoding parameter for TB1. The predetermined relationship can be any measure of a relationship between the respective encoding parameters for TB1 and TB2 including, for example, greater than, less than, equal to, less than or equal to, greater than or equal to, or the like.

Based on a determination, by the UE-A, that the encoding parameter for TB2 satisfies a predetermined relationship with respect to the encoding parameter for TB1, UE-A can continue execution of the process 600 determining 640 to encode TB1 with the IUC for transmission to the UE-B, encoding 650 the TB1 with the IUC for transmission to the UE-B, and transmitting 660 the encoded TB1 and IUC to the UE-B. Encoding TB1 with the IUC for transmission can include multiplexing TB1 with the IUC for transmission in a single transmission.

Alternatively, if at stage 630, UE-A determines that the encoding parameter for TB2 does not satisfy the predetermined relationship with respect to the encoding parameter for TB1, UE-A can continue execution of the process 600 by determining 670 to transmit TB1 and IUC to UE-B in separate transmissions.

In some implementations, the encoding parameter that is associated with of TB1 and TB2 can be a data priority. In such implementations, based on a determination, by the UE-A, that the data priority for TB2 is greater than or equal to the data priority for TB1, UE-A can determine, by the UE-A, to encode TB2 with the IUC for transmission to the UE-B.

Alternatively, based on a determination, by the UE-A, that the data priority for TB2 is less than data priority for TB1, then UE-A can determine to transmit the TB1 and the IUC to UE-B in separate transmissions.

In some implementations, the encoding parameter that is associated with of TB1 and TB2 is a packet delay budget (PDB). In such implementations, based on a determination, by the UE-A, that the PDB for TB2 does not exceed a sum of an offset and TB1's PDB, UE-A can determine to encode TB1 with the IUC for transmission to the UE-B.

In some implementations, TB1 is associated a first priority and TB2 is associated with a second priority. In such implementations, UE-A can determine a data priority for the encoded TB1 and IUC. In such implementations, the determined data priority for the encoded TB1 and IUC is selected from one of the first priority or the second priority. In some implementations, UE-A can select the higher priority of the first priority and the second priority as the data priority for the encoded TB1 and IUC.

### Receiving UE's (i.e., UE-B) Behavior Receiving Resources Set(s) From Multiple Transmitting UEs (i.e., UE-As)

In some implementations, multiple sets of non-preferred resources (S_{NP1}, S_{NP2}, . . . , S_{NPx}) can be received by UE-B from different UE-As. In such implementations, the UE-B can take the union of these sets: S_{NP}=S_{NP1}∪S_{NP2} . . . S_{NPx}.

In other implementations, the UE-B can take multiple sets of preferred resources (S_{P1}, S_{P2}, . . . , S_{Px}) from different UE-As. For example, in some implementations, the UE-B can take the union of these sets S_{P}=S_{P1}∪S_{P2} . . . S_{Px}. For example, the UE-B can select one of these sets. By way of another example, the UE-B can take the intersection of these sets S_{P}=S_{P1}∩S_{P2} . . . S_{Px}. By way of another example, the UE-B can select one of aforementioned implementations for resource set selection based on (pre-)configuration.

In other implementations, both a preferred resource set and non-preferred resource set can be used. In such implementations, the set of preferred resource sets can include S_{P}=S_{P}\S_{NP}.

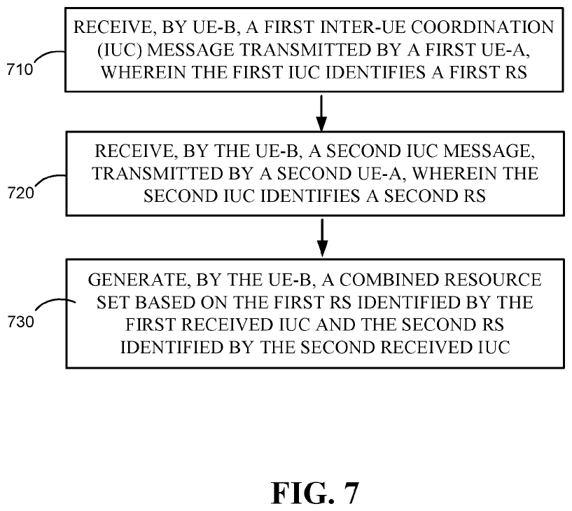

FIG. 7 is a flowchart of a process 700 for generating a combined resource set by a UE-B based on UE-B's receipt of multiple IUC messages. The process 700 will be described as being performed by a UE such as UE-B.

UE-B can begin execution of the process 700 by receiving 710 a first inter-UE coordination (IUC) message transmitted by a first UE-A. The first IUC can identify a first resource set (RS).

UE-B can continue execution of the process 700 by receiving 720 a second IUC message transmitted by a second UE-A. The second IUC can identify a second RS.

UE-B can continue execution of the process 700 by generating 730 a combined resource set based on the first RS identified by the first received IUC and the second RS identified by the second received IUC. UE-B can generate the combined resource set in a number of different ways.

In one implementation, for example, the first RS and the second RS can each include non-preferred resources. A non-preferred resource indicates that UE-B should not use the resource. In such implementations, the generation stage 730 can include UE-B generating a combined resource set based on a union between the first RS and the second RS.

In another implementation, for example, the first RS and the second RS can each include preferred resources. A preferred resource indicates that UE-B could and/or should use the resource. In such implementations, the generation stage 730 can include UE-B generating a combined resource set based a union between the first RS and the second RS. Alternatively, in such implementations, the generation stage 730 can include UE-B generating a combined resource set by taking an intersection of the first RS and the second RS. Alternatively, in such implementations, the generation stage 730 can include UE-B generating a combined resource set by selecting one of the first RS or the second RS.

In another implementation, for example, the generation stage 730 can include UE-B generating a combined resource set based on the first RS and the second RS based on (pre-)configuration of the UE-B.

In yet other implementations, the first RS and the second RS can collectively include preferred resources and non-preferred resources. In such implementations, UE-B can update the set of preferred resources to exclude the non-preferred resources.

In some implementations, UE-B can use the combined resource set or an updated resource set for UE-B's resource selection.

### Prioritizing Transmission of IUC in PSFCH

In some implementations, the present disclosure provides for prioritization among physical sidelink feedback channel (PSFCH) with IUC scheme 2 transmission/reception.

In a first implementation, the present disclosure enables resolution of collisions that occur between PSFCH with IUC scheme 2 transmission and another PSFCH with IUC scheme 2 transmission. In such implementations, due to the simultaneous transmission feature of PSFCH, the PSFCH associated with a higher data priority is transmitted.

In other implementations, the present disclosure enables resolution of collisions that occur between PSFCH with IUC scheme 2 transmission and a PSFCH with IUC scheme 2 reception. In one implementation, PSFCH with IUC scheme 2 reception is always prioritized over IUC transmissions. In other implementations, the PSFCH associated with a higher data priority is transmitted or received. In other implementations, selection between the two aforementioned implementations may be made, by UE-A, based on resource pool (pre-)configuration.

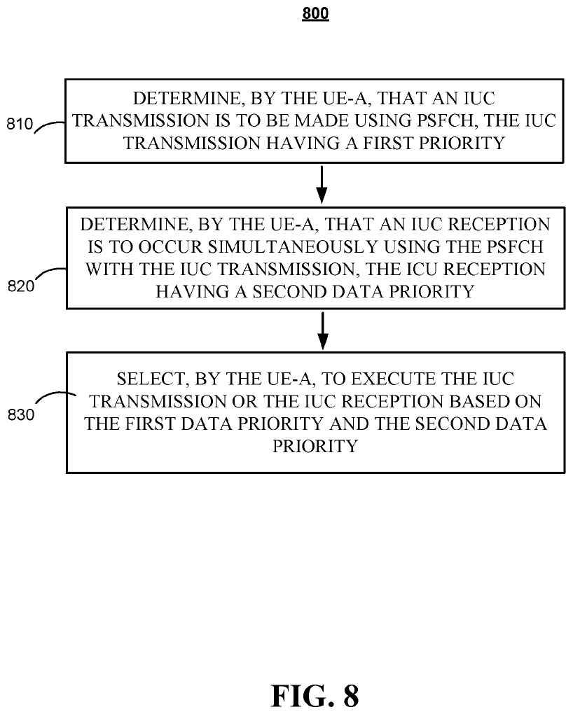

FIG. 8 is a flowchart of a process 800 for prioritizing IUC transmission in PSFCH. The process will be described as being performed by a UE such as UE-A.

UE-A can begin execution of the process 800 by determining 810 that an IUC transmission is to be made using PSFCH. In this implementation, the IUC transmission can have a first data priority. UE-A can continue execution of the process 800 by determining 820 that an IUC reception is to occur simultaneously using the PSFCH with the IUC transmission. In this implementation, the IUC reception can have a second data priority. UE-A can continue execution of the process 800 by selecting 830 to execute the IUC transmission or the IUC reception based on the first data priority and the second data priority. UE-A may perform the selecting stage 830 in a number of different ways.

In some implementations, for example, selecting at stage 830 can include UE-A determining the first data priority is greater than the second data priority. In such implementations, UE-A can execute the IUC transmission.

In other implementations, for example, selecting at stage 830 can include UE-A determining that the second data priority is greater than the first data priority value. In such implementations, UE-A can execute the IUC reception.

In other implementations, for example, selecting at stage 830 can include UE-A similarly determining that the second priority is greater than the first data priority. However, in this implementation, the decision on which IUC transmission is to be executed may be determined, dynamically, by UE-A. In such implementations, UE-A can select only one of the IUC transmission or IUC reception for execution.

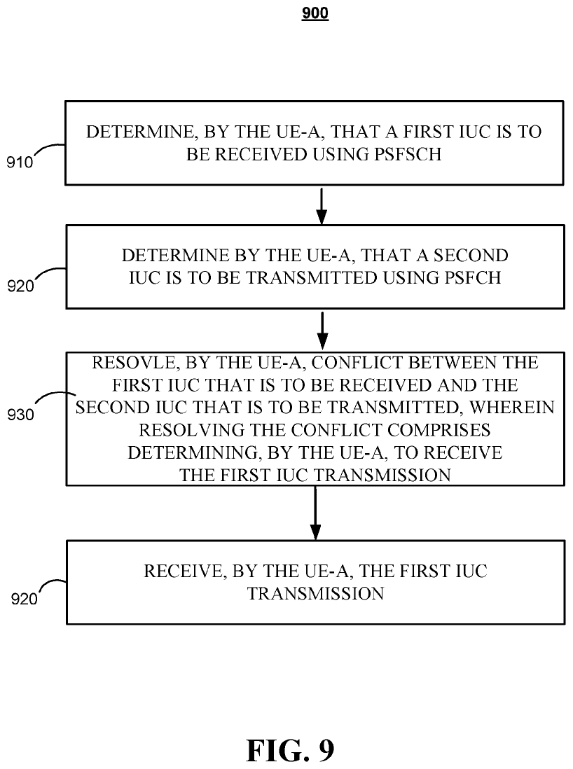

FIG. 9 is another flowchart of a process 900 for prioritizing IUC transmission in PSFCH. The process 900 will be described as being performed by a UE such as UE-A.

UE-A can begin execution of the process 900 by determining that a first IUC is to be received using PSFCH. UE-A can continue execution of the process 900 by determining that a second IUC is to be transmitted using PSFCH. UE-A can continue executing the process 900 by resolving the conflict between the first IUC that is to be received and the second IUC is to be transmitted. In this implementation, resolving the conflict between the first IUC and the second

IUC can include the UE-A determining to receive the first IUC transmission. UE-A can continue execution of the process 900 by receiving the first IUC transmission.

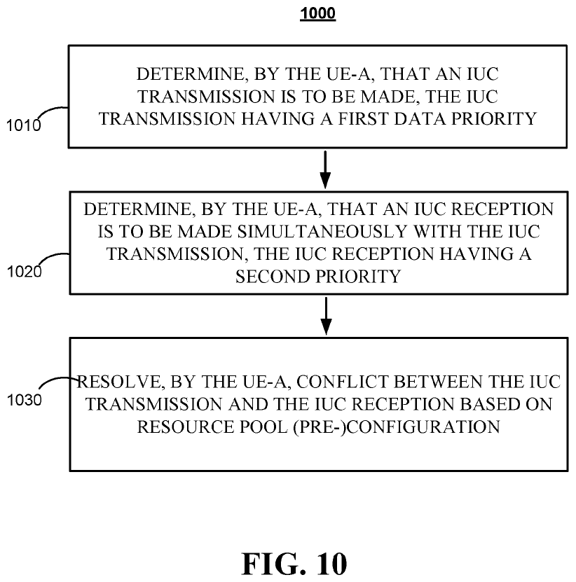

FIG. 10 is another flowchart of a process 1000 for prioritizing IUC transmission in PSFCH. The process 1000 will be described as being performed by a UE such as UE-A.

UE-A can begin performance of the process 1000 by determining 1010 that an IUC transmission is to be made. In such implementations, the IUC transmission can have a first data priority. UE-A can continue performance of the process 1000 by determining 1020 that an IUC reception is to be made simultaneously with the IUC transmission. In such implementations, the IUC reception can have a second data priority. UE-A can continue performance of the process 1000 by resolving 1030 the conflict between the IUC transmission and the IUC reception based on resource pool (pre-)configuration. UE-A may perform the resolving stage 1030 in a number of different ways.

In some implementations, for example, UE-A can resolve the conflict between the IUC transmission and the IUC reception by selecting, based on the resource pool (pre-)configuration, receipt of the IUC message.

In other implementations, for example, UE-A can resolve the conflict between the IUC transmission and the IUC reception by selecting to execute the IUC transmission or the IUC reception based on the first data priority and the second data priority. In one implementation, selecting, by UE-A, can include determining, by the UE-A, that the first data priority is greater than the second data priority and then, based on a determination by the UE-A that the first data priority is greater than the second data priority, UE-A can execute the IUC transmission. Alternatively, in another implementation, selecting, by UE-A, can include determining, by the UE-A, that the second data priority is greater than the first data priority and then, based on a determination by the UE-A that the second data priority is greater than the first data priority, UE-A can execute the IUC reception.

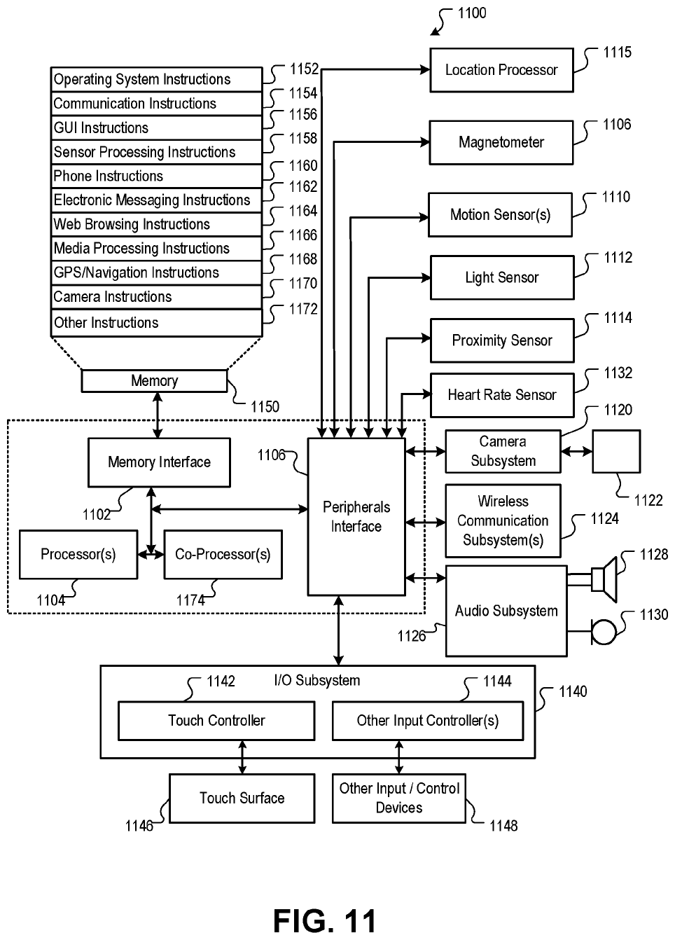

FIG. 11 is a block diagram of an example device architecture 1100 for implementing the features and processes described in reference to FIGS. 1-8. For example, the architecture 1100 can be used to implement a user equipment (UE).

The architecture 1100 can include a memory interface 1102, one or more data processor 1104, one or more data co-processors 1174, and a peripherals interface 1106. The memory interface 1102, the processor(s) 1104, the co-processor(s) 1174, and/or the peripherals interface 1106 can be separate components or can be integrated in one or more integrated circuits. One or more communication buses or signal lines may couple the various components.

The processor(s) 1104 and/or the co-processor(s) 1174 can operate in conjunction to perform the operations described herein. For instance, the processor(s) 1104 can include one or more central processing units (CPUs) that are configured to function as the primary computer processors for the architecture 1100. As an example, the processor(s) 1104 can be configured to perform generalized data processing tasks of the architecture 1100. Further, at least some of the data processing tasks can be offloaded to the co-processor(s) 1174. For example, specialized data processing tasks, such as processing motion data, processing image data, encrypting data, and/or performing certain types of arithmetic operations, can be offloaded to one or more specialized co-processor(s) 1174 for handling those tasks. In some cases, the processor(s) 1104 can be relatively more powerful than the co-processor(s) 1174 and/or can consume more power than the co-processor(s) 1174. This can be useful, for example, as it enables the processor(s) 1104 to handle generalized tasks quickly, while also offloading certain other tasks to co-processor(s) 1174 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 1104 for further analysis.

Sensors, devices, and subsystems can be coupled to peripherals interface 1106 to facilitate multiple functionalities. For example, a motion sensor 1110, a light sensor 1112, and a proximity sensor 1114 can be coupled to the peripherals interface 1106 to facilitate orientation, lighting, and proximity functions of the architecture 1100. For example, in some implementations, a light sensor 1112 can be utilized to facilitate adjusting the brightness of a touch surface 1146. In some implementations, a motion sensor 1110 can be utilized to detect movement and orientation of the device. For example, the motion sensor 1110 can include one or more accelerometers (e.g., to measure the acceleration experienced by the motion sensor 1110 and/or the architecture 1100 over a period of time), and/or one or more compasses or gyros (e.g., to measure the orientation of the motion sensor 1110 and/or the mobile device). In some cases, the measurement information obtained by the motion sensor 1110 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 1110 can be directly integrated into a co-processor 1174 configured to processes measurements obtained by the motion sensor 1110. For example, a co-processor 1174 can include one more accelerometers, compasses, and/or gyroscopes, and can be configured to obtain sensor data from each of these sensors, process the sensor data, and transmit the processed data to the processor(s) 1104 for further analysis.

Other sensors may also be connected to the peripherals interface 1106, such as a temperature sensor, a biometric sensor, or other sensing device, to facilitate related functionalities. As an example, as shown in FIG. 11, the architecture 1100 can include a heart rate sensor 1132 that measures the beats of a user's heart. Similarly, these other sensors also can be directly integrated into one or more co-processor(s) 1174 configured to process measurements obtained from those sensors.

A location processor 1115 (e.g., a GNSS receiver chip) can be connected to the peripherals interface 1106 to provide geo-referencing. An electronic magnetometer 1116 (e.g., an integrated circuit chip) can also be connected to the peripherals interface 1106 to provide data that may be used to determine the direction of magnetic North. Thus, the electronic magnetometer 1116 can be used as an electronic compass.

A camera subsystem 1120 and an optical sensor 1122 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 1124. The communication subsystem(s) 1124 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 1124 can depend on the communication network(s) or medium(s) over which the architecture 1100 is intended to operate. For example, the architecture 1100 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 1100 can be configured as a base station for other wireless devices. As another example, the communication subsystems 1124 may allow the architecture 1100 to synchronize with a host device using one or more protocols, such as, for example, the TCP/IP protocol, HTTP protocol, UDP protocol, and any other known protocol.

An audio subsystem 1126 can be coupled to a speaker 1128 and one or more microphones 1130 to facilitate voice-enabled functions, such as voice recognition, voice replication, digital recording, and telephony functions.

An I/O subsystem 1140 can include a touch controller 1142 and/or other input controller(s) 1144. The touch controller 1142 can be coupled to a touch surface 1146. The touch surface 1146 and the touch controller 1142 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 1146. In one implementations, the touch surface 1146 can display virtual or soft buttons and a virtual keyboard, which can be used as an input/output device by the user.

Other input controller(s) 1144 can be coupled to other input/control devices 1148, such as one or more buttons, rocker switches, thumb-wheel, infrared port, USB port, and/or a pointer device such as a stylus. The one or more buttons (not shown) can include an up/down button for volume control of the speaker 1128 and/or the microphone 1130.

In some implementations, the architecture 1100 can present recorded audio and/or video files, such as MP3, AAC, and MPEG video files. In some implementations, the architecture 1100 can include the functionality of an MP3 player and may include a pin connector for tethering to other devices. Other input/output and control devices may be used.

A memory interface 1102 can be coupled to a memory 1150. The memory 1150 can include high-speed random access memory or non-volatile memory, such as one or more magnetic disk storage devices, one or more optical storage devices, or flash memory (e.g., NAND, NOR). The memory 1150 can store an operating system 1152, such as Darwin, RTXC, LINUX, UNIX, OS X, WINDOWS, ANDROID, or an embedded operating system such as VxWorks. The operating system 1152 can include instructions for handling basic system services and for performing hardware dependent tasks. In some implementations, the operating system 1152 can include a kernel (e.g., UNIX kernel).

The memory 1150 can also store communication instructions 1154 to facilitate communicating with one or more additional devices, one or more computers or servers, including peer-to-peer communications. The communication instructions 1154 can also be used to select an operational mode or communication medium for use by the device, based on a geographic location (obtained by the GPS/Navigation instructions 1168) of the device. The memory 1150 can include graphical user interface instructions 1156 to facilitate graphic user interface processing, including a touch model for interpreting touch inputs and gestures; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GPS/Navigation instructions 1168 to facilitate GPS and navigation-related processes; camera instructions 1170 to facilitate camera-related processes and functions; and other instructions 1172 for performing some or all of the processes described herein.

Each of the above identified instructions and applications can correspond to a set of instructions for performing one or more functions described herein. These instructions need not be implemented as separate software programs, procedures, or modules. The memory 1150 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems.

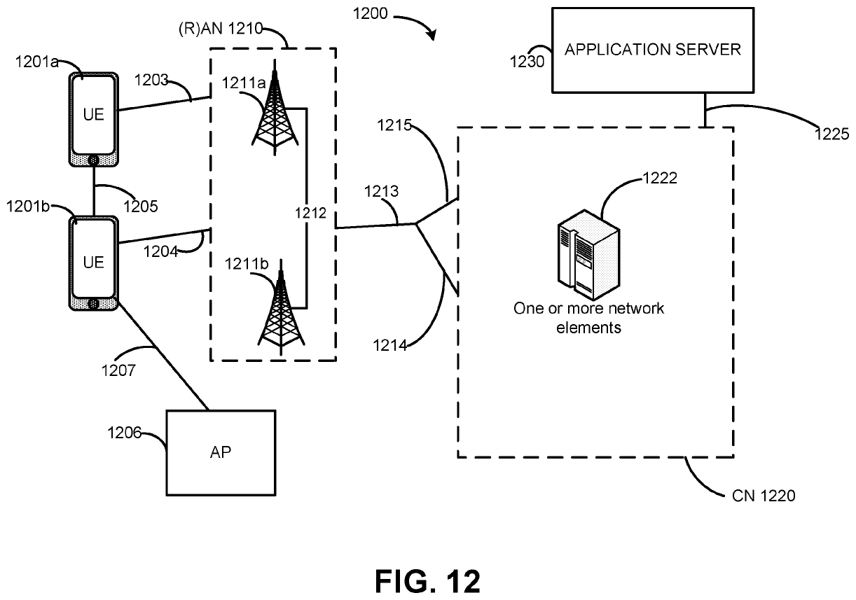

FIG. 12 illustrates an example of a wireless communication system 1200. For purposes of convenience and without limitation, the example system 1200 is described in the context of Long Term Evolution (LTE) and Fifth Generation (5G) New Radio (NR) communication standards as defined by the Third Generation Partnership Project (3GPP) technical specifications. More specifically, the wireless communication system 1200 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 1200 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like.

As shown by FIG. 12, the system 1200 includes UE 1201a and UE 1201b (collectively referred to as “UEs 1201” or “UE 1201”). In this example, UEs 1201 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 1201 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 may be configured to connect, for example, communicatively couple, with RAN 1210. In embodiments, the RAN 1210 may be an NG RAN or a 5G RAN, an E-UTRAN, a non-terrestrial cell, or a legacy RAN, such as a UTRAN or GERAN. As used herein, the term “NG RAN” or the like may refer to a RAN 1210 that operates in an NR or 5G system 1200, and the term “E-UTRAN” or the like may refer to a RAN 1210 that operates in an LTE or 4G system 1200. The UEs 1201 utilize connections (or channels) 1203 and 1204, respectively, each of which comprises a physical communications interface or layer (discussed in further detail below).

In this example, the connections 1203 and 1204 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UEs 1201 may directly exchange communication data via a ProSe interface 1205. The ProSe interface 1205 may alternatively be referred to as a SL interface 1205 and may comprise one or more logical channels, including but not limited to a PSCCH, a PSSCH, a PSDCH, and a PSBCH.

The UE 1201b is shown to be configured to access an AP 1206 (also referred to as “WLAN node 1206,” “WLAN 1206,” “WLAN Termination 1206,” “WT 1206” or the like) via connection 1207. The connection 1207 can comprise a local wireless connection, such as a connection consistent with any IEEE 802.11 protocol, wherein the AP 1206 would comprise a wireless fidelity (Wi-Fi®) router. In this example, the AP 1206 is shown to be connected to the Internet without connecting to the core network of the wireless system (described in further detail below). In various embodiments, the UE 1201b, RAN 1210, and AP 1206 may be configured to utilize LWA operation and/or LWIP operation. The LWA operation may involve the UE 1201b in RRC_CONNECTED being configured by a RAN node 1211a-b to utilize radio resources of LTE and WLAN. LWIP operation may involve the UE 1201b using WLAN radio resources (e.g., connection 1207) via IPsec protocol tunneling to authenticate and encrypt packets (e.g., IP packets) sent over the connection 1207. IPsec tunneling may include encapsulating the entirety of original IP packets and adding a new packet header, thereby protecting the original header of the IP packets.

The RAN 1210 can include one or more AN nodes or RAN nodes 1211a and 1211b (collectively referred to as “RAN nodes 1211” or “RAN node 1211”) that enable the connections 1203 and 1204. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 1211 that operates in an NR or 5G system 1200 (for example, a gNB), and the term “E-UTRAN node” or the like may refer to a RAN node 1211 that operates in an LTE or 4G system 1200 (e.g., an eNB). According to various embodiments, the RAN nodes 1211 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 1211 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 1211; a MAC/PHY split wherein RRC, PDCP, RLC, and MAC layers are operated by the CRAN/vBBUP and the PHY layer is operated by individual RAN nodes 1211; or a “lower PHY” split wherein RRC, PDCP, RLC, MAC layers and upper portions of the PHY layer are operated by the CRAN/vBBUP and lower portions of the PHY layer are operated by individual RAN nodes 1211. This virtualized framework allows the freed-up processor cores of the RAN nodes 1211 to perform other virtualized applications. In some implementations, an individual RAN node 1211 may represent individual gNB-DUs that are connected to a gNB-CU via individual F1 interfaces (not shown by FIG. 12). In these implementations, the gNB-DUs may include one or more remote radio heads or RFEMs (see, e.g., FIG. 11), and the gNB-CU may be operated by a server that is located in the RAN 1210 (not shown) or by a server pool in a similar manner as the CRAN/vBBUP. Additionally or alternatively, one or more of the RAN nodes 1211 may be next generation eNBs (ng-eNBs), which are RAN nodes that provide E-UTRA user plane and control plane protocol terminations toward the UEs 1201, and are connected to a 5GC via an NG interface (discussed infra).

In V2X scenarios one or more of the RAN nodes 1211 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 1201 (vUEs 1201). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 1211 can terminate the air interface protocol and can be the first point of contact for the UEs 1201. In some embodiments, any of the RAN nodes 1211 can fulfill various logical functions for the RAN 1210 including, but not limited to, radio network controller (RNC) functions such as radio bearer management, uplink and downlink dynamic radio resource management and data packet scheduling, and mobility management.

In embodiments, the UEs 1201 can be configured to communicate using OFDM communication signals with each other or with any of the RAN nodes 1211 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 to the UEs 1201, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 1201 and the RAN nodes 1211 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band. NR in the unlicensed spectrum may be referred to as NR-U, and LTE in an unlicensed spectrum may be referred to as LTE-U, licensed assisted access (LAA), or MulteFire.

To operate in the unlicensed spectrum, the UEs 1201 and the RAN nodes 1211 may operate using LAA, eLAA, and/or feLAA mechanisms. In these implementations, the UEs 1201 and the RAN nodes 1211 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 1201 RAN nodes 1211, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 1201, AP 1206, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds(s); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 1201 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 1201. The PDCCH carries information about the transport format and resource allocations related to the PDSCH channel, among other things. It may also inform the UEs 1201 about the transport format, resource allocation, and HARQ information related to the uplink shared channel. Typically, downlink scheduling (assigning control and shared channel resource blocks to the UE 1201b within a cell) may be performed at any of the RAN nodes 1211 based on channel quality information fed back from any of the UEs 1201. The downlink resource assignment information may be sent on the PDCCH used for (e.g., assigned to) each of the UEs 1201.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 1211 may be configured to communicate with one another via interface 1212. In embodiments where the system 1200 is an LTE system, the interface 1212 may be an X2 interface 1212. The X2 interface may be defined between two or more RAN nodes 1211 (e.g., two or more eNBs and the like) that connect to EPC 1220, and/or between two eNBs connecting to EPC 1220. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 1201 from an SeNB for user data; information of PDCP PDUs that were not delivered to a UE 1201; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 1200 is a 5G or NR system, the interface 1212 may be an Xn interface 1212. The Xn interface is defined between two or more RAN nodes 1211 (e.g., two or more gNBs and the like) that connect to 5GC 1220, between a RAN node 1211 (e.g., a gNB) connecting to 5GC 1220 and an eNB, and/or between two eNBs connecting to 5GC 1220. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1201 in a connected mode (e.g., CM-CONNECTED) including functionality to manage the UE mobility for connected mode between one or more RAN nodes 1211. The mobility support may include context transfer from an old (source) serving RAN node 1211 to new (target) serving RAN node 1211; and control of user plane tunnels between old (source) serving RAN node 1211 to new (target) serving RAN node 1211. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 1210 is shown to be communicatively coupled to a core network-in this embodiment, core network (CN) 1220. The CN 1220 may comprise a plurality of network elements 1222, which are configured to offer various data and telecommunications services to customers/subscribers (e.g., users of UEs 1201) who are connected to the CN 1220 via the RAN 1210. The components of the CN 1220 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 1220 may be referred to as a network slice, and a logical instantiation of a portion of the CN 1220 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 1230 may be an element offering applications that use IP bearer resources with the core network (e.g., UMTS PS domain, LTE PS data services, etc.). The application server 1230 can also be configured to support one or more communication services (e.g., VoIP sessions, PTT sessions, group communication sessions, social networking services, etc.) for the UEs 1201 via the EPC 1220.

In embodiments, the CN 1220 may be a 5GC (referred to as “5GC 1220” or the like), and the RAN 1210 may be connected with the CN 1220 via an NG interface 1213. In embodiments, the NG interface 1213 may be split into two parts, an NG user plane (NG-U) interface 1214, which carries traffic data between the RAN nodes 1211 and a UPF, and the S1 control plane (NG-C) interface 1215, which is a signaling interface between the RAN nodes 1211 and AMFs.

In embodiments, the CN 1220 may be a 5G CN (referred to as “5GC 1220” or the like), while in other embodiments, the CN 1220 may be an EPC). Where CN 1220 is an EPC (referred to as “EPC 1220” or the like), the RAN 1210 may be connected with the CN 1220 via an S1 interface 1213. In embodiments, the S1 interface 1213 may be split into two parts, an S1 user plane (S1-U) interface 1214, which carries traffic data between the RAN nodes 1211 and the S-GW, and the S1-MME interface 1215, which is a signaling interface between the RAN nodes 1211 and MMEs.

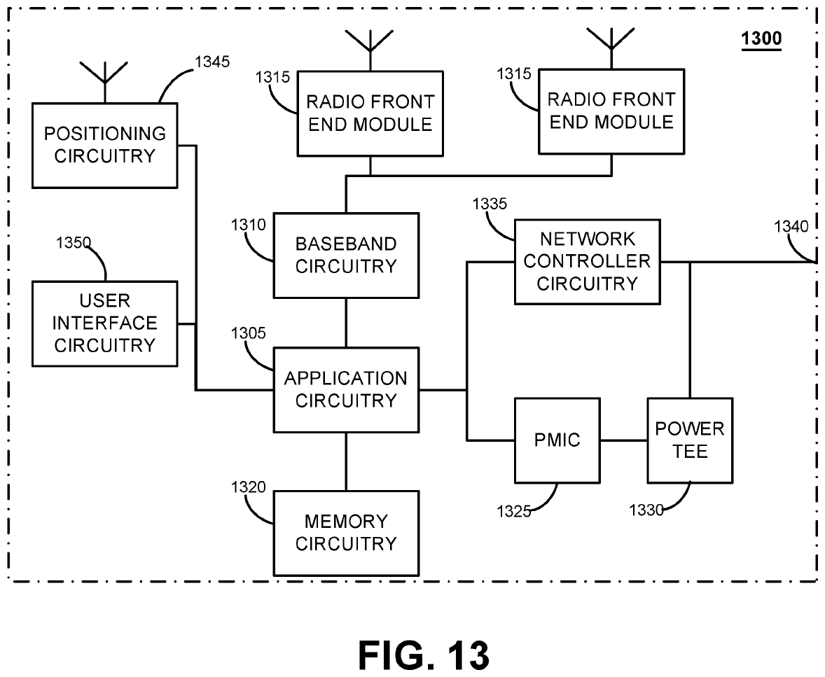

FIG. 13 illustrates an example of infrastructure equipment 1300 in accordance with various embodiments. The infrastructure equipment 1300 (or “system 1300”) may be implemented as a base station, radio head, non-terrestrial base station, RAN node such as the RAN nodes 1211 and/or AP 1206 shown and described previously, application server(s) 1230, and/or any other element/device discussed herein. In other examples, the system 1300 could be implemented in or by a UE.

The system 1300 includes application circuitry 1305, baseband circuitry 1310, one or more radio front end modules (RFEMs) 1315, memory circuitry 1320, power management integrated circuitry (PMIC) 1325, power tee circuitry 1330, network controller circuitry 1335, network interface connector 1340, satellite positioning circuitry 1345, and user interface 1350. In some embodiments, the device 1300 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 1305 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1305 may be coupled with or may include memory/storage elements and may be configured to execute instructions stored in the memory/storage to enable various applications or operating systems to run on the system 1300. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 1305 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 1305 may comprise, or may be, a special-purpose processor/controller to operate according to the various embodiments herein. As examples, the processor(s) of application circuitry 1305 may include one or more may include one or more Apple A-series processors, Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. Such as the ARM Cortex-A family of processors and the ThunderX2® provided by Cavium™, Inc.; a MIPS-based design from MIPS Technologies, Inc. Such as MIPS Warrior P-class processors; and/or the like. In some embodiments, the system 1300 may not utilize application circuitry 1305, and instead may include a special-purpose processor/controller to process IP data received from an EPC or 5GC, for example.

In some implementations, the application circuitry 1305 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 1305 may comprise logic blocks or logic fabric, and other interconnected resources that may be programmed to perform various functions, such as the procedures, methods, functions, etc. Of the various embodiments discussed herein. In such embodiments, the circuitry of application circuitry 1305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. In look-up-tables (LUTs) and the like.

The baseband circuitry 1310 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 1310 are discussed infra with regard to FIG. 12.

User interface circuitry 1350 may include one or more user interfaces designed to enable user interaction with the system 1300 or peripheral component interfaces designed to enable peripheral component interaction with the system 1300. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

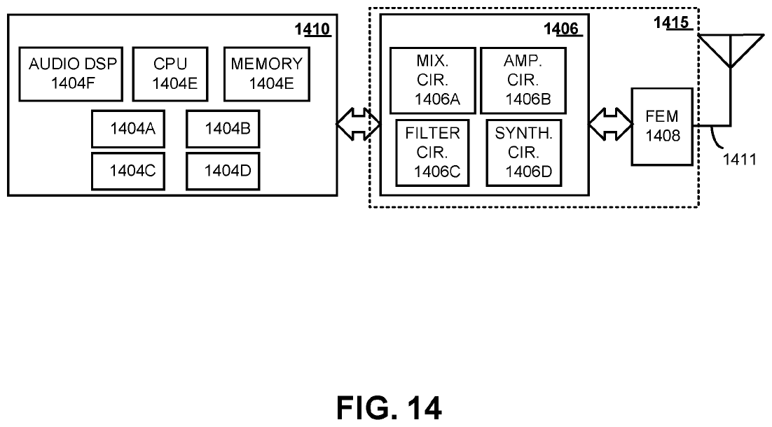

The radio front end modules (RFEMs) 1315 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 1411 of FIG. 14 infra), and the RFEM may be connected to multiple antennas. In alternative implementations, both mmWave and sub-mmWave radio functions may be implemented in the same physical RFEM 1315, which incorporates both mmWave antennas and sub-mmWave.

The memory circuitry 1320 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 1320 may be implemented as one or more of solder down packaged integrated circuits, socketed memory modules and plug-in memory cards.

The PMIC 1325 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 1330 may provide for electrical power drawn from a network cable to provide both power supply and data connectivity to the infrastructure equipment 1300 using a single cable.

The network controller circuitry 1335 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 1300 via network interface connector 1340 using a physical connection, which may be electrical (commonly referred to as a “copper interconnect”), optical, or wireless. The network controller circuitry 1335 may include one or more dedicated processors and/or FPGAs to communicate using one or more of the aforementioned protocols. In some implementations, the network controller circuitry 1335 may include multiple controllers to provide connectivity to other networks using the same or different protocols.

The positioning circuitry 1345 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1345 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1345 may include a Micro-Technology for Positioning, Navigation, and Timing (Micro-PNT) IC that uses a master timing clock to perform position tracking/estimation without GNSS assistance. The positioning circuitry 1345 may also be part of, or interact with, the baseband circuitry 1310 and/or RFEMs 1315 to communicate with the nodes and components of the positioning network. The positioning circuitry 1345 may also provide position data and/or time data to the application circuitry 1305, which may use the data to synchronize operations with various infrastructure (e.g., RAN nodes 1211, etc.), or the like.

The components shown by FIG. 13 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 14 illustrates example components of baseband circuitry 1410 and radio front end modules (RFEM) 1415 in accordance with various embodiments. The baseband circuitry 1410 corresponds to the baseband circuitry 1310 of FIG. 13. The RFEM 1415 corresponds to the RFEM 1315 of FIG. 13. As shown, the RFEMs 1415 may include Radio Frequency (RF) circuitry 1406, front-end module (FEM) circuitry 1408, antenna array 1411 coupled together at least as shown.

The baseband circuitry 1410 includes circuitry and/or control logic configured to carry out various radio/network protocol and radio control functions that enable communication with one or more radio networks via the RF circuitry 1406. The radio control functions may include, but are not limited to, signal modulation/demodulation, encoding/decoding, radio frequency shifting, etc. In some embodiments, modulation/demodulation circuitry of the baseband circuitry 1410 may include Fast-Fourier Transform (FFT), precoding, or constellation mapping/demapping functionality. In some embodiments, encoding/decoding circuitry of the baseband circuitry 1410 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 1410 is configured to process baseband signals received from a receive signal path of the RF circuitry 1406 and to generate baseband signals for a transmit signal path of the RF circuitry 1406. The baseband circuitry 1410 is configured to interface with application circuitry 1305 (see FIG. 13) for generation and processing of the baseband signals and for controlling operations of the RF circuitry 1406. The baseband circuitry 1410 may handle various radio control functions.

The aforementioned circuitry and/or control logic of the baseband circuitry 1410 may include one or more single or multi-core processors. For example, the one or more processors may include a 3G baseband processor 1404A, a 4G/LTE baseband processor 1404B, a 5G/NR baseband processor 1404C, or some other baseband processor(s) 1404D for other existing generations, generations in development or to be developed in the future (e.g., sixth generation (6G), etc.). In other embodiments, some or all of the functionality of baseband processors 1404A-D may be included in modules stored in the memory 1404G and executed via a Central Processing Unit (CPU) 1404E. In other embodiments, some or all of the functionality of baseband processors 1404A-D may be provided as hardware accelerators (e.g., FPGAs, ASICS, etc.) loaded with the appropriate bit streams or logic blocks stored in respective memory cells. In various embodiments, the memory 1404G may store program code of a real-time OS (RTOS), which when executed by the CPU 1404E (or other baseband processor), is to cause the CPU 1404E (or other baseband processor) to manage resources of the baseband circuitry 1410, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKLA provided by Open Kernel (OK) Labs®, or any other suitable RTOS, such as those discussed herein. In addition, the baseband circuitry 1410 includes one or more audio digital signal processor(s) (DSP) 1404F. The audio DSP(s) 1404F include elements for compression/decompression and echo cancellation and may include other suitable processing elements in other embodiments.

In some embodiments, each of the processors 1404A-1204E include respective memory interfaces to send/receive data to/from the memory 1404G. The baseband circuitry 1410 may further include one or more interfaces to communicatively couple to other circuitries/devices, such as an interface to send/receive data to/from memory external to the baseband circuitry 1410; an application circuitry interface to send/receive data to/from the application circuitry 1305 of FIG. 13); an RF circuitry interface to send/receive data to/from RF circuitry 1406 of FIG. 14; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from a PMIC.

In alternate embodiments (which may be combined with the above described embodiments), baseband circuitry 1410 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 1410 may include protocol processing circuitry with one or more instances of control circuitry (not shown) to provide control functions for the digital baseband circuitry and/or radio frequency circuitry (e.g., the radio front end modules 1415).

Although not shown by FIG. 14, in some embodiments, the baseband circuitry 1410 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 1410 and/or RF circuitry 1406 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 1410 and/or RF circuitry 1406 are part of a Wi-Fi communication system. In the second example, the protocol processing circuitry would operate Wi-Fi MAC and logical link control (LLC) functions. The protocol processing circuitry may include one or more memory structures (e.g., 1404) to store program code and data for operating the protocol functions, as well as one or more processing cores to execute the program code and perform various operations using the data. The baseband circuitry 1410 may also support radio communications for more than one wireless protocol.

The various hardware elements of the baseband circuitry 1410 discussed herein may be implemented, for example, as a solder-down substrate including one or more integrated circuits (ICs), a single packaged IC soldered to a main circuit board or a multi-chip module containing two or more ICs. In one example, the components of the baseband circuitry 1410 may be suitably combined in a single chip or chipset, or disposed on a same circuit board. In another example, some or all of the constituent components of the baseband circuitry 1410 and RF circuitry 1406 may be implemented together such as, for example, a system on a chip (SoC) or System-in-Package (SiP). In another example, some or all of the constituent components of the baseband circuitry 1410 may be implemented as a separate SoC that is communicatively coupled with and RF circuitry 1406 (or multiple instances of RF circuitry 1406). In yet another example, some or all of the constituent components of the baseband circuitry 1410 and the application circuitry 1305 may be implemented together as individual SoCs mounted to a same circuit board (e.g., a “multi-chip package”).

In some embodiments, the baseband circuitry 1410 may provide for communication compatible with one or more radio technologies. For example, in some embodiments, the baseband circuitry 1410 may support communication with an E-UTRAN or other WMAN, a

WLAN, a WPAN. Embodiments in which the baseband circuitry 1410 is configured to support radio communications of more than one wireless protocol may be referred to as multi-mode baseband circuitry.

RF circuitry 1406 may enable communication with wireless networks using modulated electromagnetic radiation through a non-solid medium. In various embodiments, the RF circuitry 1406 may include switches, filters, amplifiers, etc. To facilitate the communication with the wireless network. RF circuitry 1406 may include a receive signal path, which may include circuitry to down-convert RF signals received from the FEM circuitry 1408 and provide baseband signals to the baseband circuitry 1410. RF circuitry 1406 may also include a transmit signal path, which may include circuitry to up-convert baseband signals provided by the baseband circuitry 1410 and provide RF output signals to the FEM circuitry 1408 for transmission.

In some embodiments, the receive signal path of the RF circuitry 1406 may include mixer circuitry 1406a, amplifier circuitry 1406b and filter circuitry 1406c. In some embodiments, the transmit signal path of the RF circuitry 1406 may include filter circuitry 1406c and mixer circuitry 1406a. RF circuitry 1406 may also include synthesizer circuitry 1406d for synthesizing a frequency for use by the mixer circuitry 1406a of the receive signal path and the transmit signal path. In some embodiments, the mixer circuitry 1406a of the receive signal path may be configured to down-convert RF signals received from the FEM circuitry 1408 based on the synthesized frequency provided by synthesizer circuitry 1406d. The amplifier circuitry 1406b may be configured to amplify the down-converted signals and the filter circuitry 1406c may be a low-pass filter (LPF) or band-pass filter (BPF) configured to remove unwanted signals from the down-converted signals to generate output baseband signals. Output baseband signals may be provided to the baseband circuitry 1410 for further processing. In some embodiments, the output baseband signals may be zero-frequency baseband signals, although this is not a requirement. In some embodiments, mixer circuitry 1406a of the receive signal path may comprise passive mixers, although the scope of the embodiments is not limited in this respect.

In some embodiments, the mixer circuitry 1406a of the transmit signal path may be configured to up-convert input baseband signals based on the synthesized frequency provided by the synthesizer circuitry 1406d to generate RF output signals for the FEM circuitry 1408. The baseband signals may be provided by the baseband circuitry 1410 and may be filtered by filter circuitry 1406c.

In some embodiments, the mixer circuitry 1406a of the receive signal path and the mixer circuitry 1406a of the transmit signal path may include two or more mixers and may be arranged for quadrature downconversion and upconversion, respectively. In some embodiments, the mixer circuitry 1406a of the receive signal path and the mixer circuitry 1406a of the transmit signal path may include two or more mixers and may be arranged for image rejection (e.g., Hartley image rejection). In some embodiments, the mixer circuitry 1406a of the receive signal path and the mixer circuitry 1406a of the transmit signal path may be arranged for direct downconversion and direct upconversion, respectively. In some embodiments, the mixer circuitry 1406a of the receive signal path and the mixer circuitry 1406a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1406 may include analog-to-digital converter (ADC) and digital-to-analog converter (DAC) circuitry and the baseband circuitry 1410 may include a digital baseband interface to communicate with the RF circuitry 1406.

In some dual-mode embodiments, a separate radio IC circuitry may be provided for processing signals for each spectrum, although the scope of the embodiments is not limited in this respect.

In some embodiments, the synthesizer circuitry 1406d may be a fractional-N synthesizer or a fractional N/N+1 synthesizer, although the scope of the embodiments is not limited in this respect as other types of frequency synthesizers may be suitable. For example, synthesizer circuitry 1406d may be a delta-sigma synthesizer, a frequency multiplier, or a synthesizer comprising a phase-locked loop with a frequency divider.

The synthesizer circuitry 1406d may be configured to synthesize an output frequency for use by the mixer circuitry 1406a of the RF circuitry 1406 based on a frequency input and a divider control input. In some embodiments, the synthesizer circuitry 1406d may be a fractional N/N+1 synthesizer.

In some embodiments, frequency input may be provided by a voltage controlled oscillator (VCO), although that is not a requirement. Divider control input may be provided by either the baseband circuitry 1410 or the application circuitry 1305 depending on the desired output frequency. In some embodiments, a divider control input (e.g., N) may be determined from a look-up table based on a channel indicated by the application circuitry 1305.

Synthesizer circuitry 1406d of the RF circuitry 1406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1406d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1406 may include an IQ/polar converter.

FEM circuitry 1408 may include a receive signal path, which may include circuitry configured to operate on RF signals received from antenna array 1411, amplify the received signals and provide the amplified versions of the received signals to the RF circuitry 1406 for further processing. FEM circuitry 1408 may also include a transmit signal path, which may include circuitry configured to amplify signals for transmission provided by the RF circuitry 1406 for transmission by one or more of antenna elements of antenna array 1411. In various embodiments, the amplification through the transmit or receive signal paths may be done solely in the RF circuitry 1406, solely in the FEM circuitry 1408, or in both the RF circuitry 1406 and the FEM circuitry 1408.

In some embodiments, the FEM circuitry 1408 may include a TX/RX switch to switch between transmit mode and receive mode operation. The FEM circuitry 1408 may include a receive signal path and a transmit signal path. The receive signal path of the FEM circuitry 1408 may include an LNA to amplify received RF signals and provide the amplified received RF signals as an output (e.g., to the RF circuitry 1406). The transmit signal path of the FEM circuitry 1408 may include a power amplifier (PA) to amplify input RF signals (e.g., provided by RF circuitry 1406), and one or more filters to generate RF signals for subsequent transmission by one or more antenna elements of the antenna array 1411.

The antenna array 1411 comprises one or more antenna elements, each of which is configured convert electrical signals into radio waves to travel through the air and to convert received radio waves into electrical signals. For example, digital baseband signals provided by the baseband circuitry 1410 is converted into analog RF signals (e.g., modulated waveform) that will be amplified and transmitted via the antenna elements of the antenna array 1411 including one or more antenna elements (not shown). The antenna elements may be omnidirectional, direction, or a combination thereof. The antenna elements may be formed in a multitude of arranges as are known and/or discussed herein. The antenna array 1411 may comprise microstrip antennas or printed antennas that are fabricated on the surface of one or more printed circuit boards. The antenna array 1411 may be formed in as a patch of metal foil (e.g., a patch antenna) in a variety of shapes, and may be coupled with the RF circuitry 1406 and/or FEM circuitry 1408 using metal transmission lines or the like.

Processors of the application circuitry 1305 and processors of the baseband circuitry 1410 may be used to execute elements of one or more instances of a protocol stack. For example, processors of the baseband circuitry 1410, alone or in combination, may be used execute Layer 3, Layer 2, or Layer 1 functionality, while processors of the application circuitry 1305 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

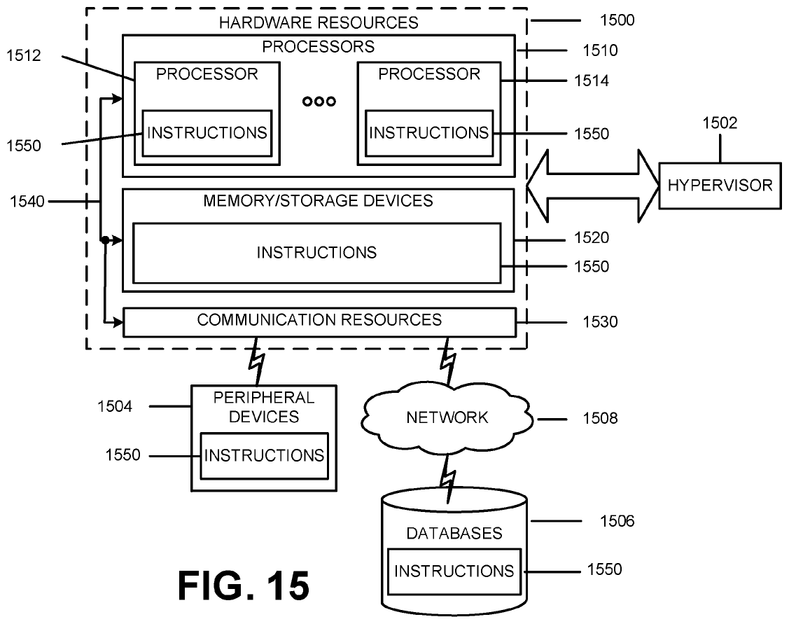

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 may include, for example, a processor 1512 and a processor 1514. The processor(s) 1510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1520 may include main memory, disk storage, or any suitable combination thereof. The memory/storage devices 1520 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via USB), cellular communication components, NFC components, Bluetooth® (or Bluetooth® Low Energy) components, Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-257. (canceled)

258. One or more processors configured to, when executing instructions stored in a memory, perform operations comprising:
causing transmission of sidelink control information (SCI) in accordance with a first inter-user equipment (UE) coordination scheme, the SCI comprising inter-user equipment (UE) coordination information that indicates a preferred or non-preferred resource set for a sidelink transmission, wherein the preferred or non-preferred resource set is indicated by one or more resource indicator value (TRIV), frequency resource indicator value (FRIV), and periodicity combinations, and wherein a maximum number of TRIV, FRIV, and periodicity combinations indicated by the SCI is fixed; and
receiving the sidelink transmission based at least in part on the inter-UE coordination information provided via the SCI.

259. The one or more processors of claim 258, wherein a first resource location of each TRIV is indicated by a slot offset in logical slots with respect to a reference slot.

260. The one or more processors of claim 259, wherein the reference slot is indicated by a field of the SCI.

261. The one or more processors of claim 258, wherein at least one field is omitted from the SCI when transmission of the inter-UE coordination information is triggered by an explicit request.

262. The one or more processors of claim 258, further comprising determining whether to transmit the inter-UE coordination information via second stage SCI or a medium access control (MAC) control element (CE) based at least in part on the maximum number of TRIV, FRIV, and periodicity combinations indicated by the SCI.

263. The one or more processors of claim 258, wherein the maximum number of TRIV, FRIV, and periodicity combinations indicated by the SCI is 3.

264. The one or more processors of claim 258, wherein a field of the SCI indicates a number of TRIV, FRIV, and periodicity combinations that are used to indicate the preferred or non-preferred resource set.

265. The one or more processors of claim 264, further comprising determining a size of a field in the SCI based at least in part on the number of TRIV, FRIV, and periodicity combinations used to indicate the preferred or non-preferred resource set.

266. One or more processors configured to, when executing instructions stored in a memory, perform operations comprising:
receiving sidelink control information (SCI) in accordance with a first inter-user equipment (UE) coordination scheme, the SCI comprising inter-user equipment (UE) coordination information that indicates a preferred or non-preferred resource set for a sidelink transmission, wherein the preferred or non-preferred resource set is indicated by one or more resource indicator value (TRIV), frequency resource indicator value (FRIV), and periodicity combinations, and wherein a maximum number of TRIV, FRIV, and periodicity combinations indicated by the SCI is fixed; and
causing transmission of the sidelink transmission based at least in part on the inter-UE coordination information provided via the SCI.

267. The one or more processors of claim 266, wherein a first resource location of each TRIV is indicated by a slot offset in logical slots with respect to a reference slot.

268. The one or more processors of claim 267, wherein the reference slot is indicated by a field of the SCI.

269. The one or more processors of claim 266, wherein at least one field is omitted from the SCI when transmission of the inter-UE coordination information is triggered by an explicit request.

270. The one or more processors of claim 266, wherein the maximum number of TRIV, FRIV, and periodicity combinations indicated by the SCI is 3.

271. The one or more processors of claim 266, wherein a field of the SCI indicates a number of TRIV, FRIV, and periodicity combinations that are used to indicate the preferred or non-preferred resource set.

272. The one or more processors of claim 266, further comprising determining a size of a field in the SCI based at least in part on the number of TRIV, FRIV, and periodicity combinations used to indicate the preferred or non-preferred resource set.

273. One or more processors configured to, when executing instructions stored in a memory, perform operations comprising:
causing transmission of sidelink control information (SCI) in accordance with a first inter-user equipment (UE) coordination scheme, the SCI comprising inter-user equipment (UE) coordination information that indicates a reference slot and a preferred or non-preferred resource set for a sidelink transmission, wherein the preferred or non-preferred resource set is indicated with respect to the reference slot; and
receiving the sidelink transmission based at least in part on the inter-UE coordination information provided via the SCI.

274. The one or more processors of claim 273, wherein the preferred or non-preferred resource set is indicated by the reference slot and one or more time resource indicator value (TRIV), frequency resource indicator value (FRIV), and periodicity combinations indicated by the SCI.

275. The one or more processors of claim 273, wherein a first resource location of each TRIV is indicated by a slot offset in logical slots with respect to the reference slot.

276. The one or more processors of claim 273, wherein the slot offset is indicated by a field of the SCI.

277. The one or more processors of claim 273, wherein the SCI indicates the reference slot as a combination of a frequency value and a slot identifier.
